(19) United States
(12) Patent Application Publication
(10) Pub. No.: US 2024/0075730 A1
(43) Pub. Date: Mar. 7, 2024

(54) METHODS TO MANUFACTURE A BUILDING PANEL WITH BEVEL

(71) Applicant: Välinge Innovation AB, Viken (SE)

(72) Inventors: Lucas LARSSON, HÖGANÄS (SE); Martin BJEREMYR, HELSINGBORG (SE); Per JOSEFSSON, RAMLÖSA (SE); Peter DERELÖV, HELSINGBORG (SE)

(73) Assignee: Välinge Innovation AB, Viken (SE)

(21) Appl. No.: 18/243,224

(22) Filed: Sep. 7, 2023

(30) Foreign Application Priority Data
Sep. 7, 2022 (SE) 2251040-8

(51) Int. Cl. B32B 38/00; B32B 3/06; B32B 3/26; B32B 9/00; B32B 9/04; B32B 27/20; B32B 27/22; B32B 27/30; B32B 37/06; B32B 37/08; B32B 37/18; E04F 13/08; E04F 15/02; E04F 15/10

(52) U.S. Cl. CPC B32B 38/0012; B32B 3/06; B32B 3/263; B32B 9/002; B32B 9/045; B32B 27/20; B32B 27/22; B32B 27/304; B32B 37/06; B32B 37/08; B32B 37/182; B32B 38/0004; E04F 13/0866; E04F 13/0894; E04F 15/02033; E04F 15/02038; E04F 15/107; B32B 2264/104; B32B 2307/554; B32B 2318/04; B32B 2327/06; B32B 2607/00; E04F 2201/023; E04F 2201/043

(57) ABSTRACT

A building panel and a method for manufacturing such a building panel where the building panel may be e.g. a floor panel or wall panel. The method including joining a substrate material and a sublayer material to form a substrate and a sublayer of the building panel. The method further includes applying a surface layer on the sublayer, applying pressure to form the building panel, and forming a bevel along at least one edge of the building panel by means of a pressing device. The sublayer is configured to be at least partly plastically deformable when pressure is applied in order to at least form the bevel of the building panel.

### FIELD OF THE INVENTIVE CONCEPT

The present inventive concept relates to a building panel, e.g., a floor panel or wall panel, to a panel board from which building panels may be created, and to methods of manufacturing such a building panel. Specifically, the present inventive concept relates to a building panel with bevel and to a method of manufacturing such bevel.

### TECHNICAL BACKGROUND

Building panels such as Luxury Vinyl Tiles (LVT) or Stone Plastic Composite panels (SPC panels) are examples of very popular building panels, especially flooring panels, which have the advantages of being durable and easy to maintain.

A SPC panel is a more rigid panel than a LVT panel, having a modulus of elasticity of 2 000-12 000 MPa and often containing inorganic fillers, such as chalk, at an amount of 50-90 wt %. A LVT panel usually has amodulus of elasticity of less than 2 000 MPa.

However, such panels often have limitations and disadvantages in their manufacturing process, as the core of these panels are often made of highly filled thermoplastic material, thermosetting materials, hard wood based boards or inorganic material such as mineral based materials. These types of cores are usually very hard and therefore rather difficult to make a desirable embossing and/or bevel on. For example, if an SPC board or another thermoplastic board were to be laminated, embossed and/or provided with a bevel it would be necessary to use a lot of surface material to achieve a proper and desirable shape of the embossing and/or bevel. Further, if a highly filled thermoplastic board or a mineral-based board, like an MgO-board, is to be laminated with a thin thermoplastic décor layer it would likewise be very difficult to achieve a proper embossing and/or bevel.

In manufacturing processes used today this disadvantage is overcome by using high temperatures, high pressure, long pressing times and/or thick layers of material, e.g. powder or surface layers. This leads to inefficient manufacturing processes or expensive and material consuming manufacturing processes.

### SUMMARY

An object of at least embodiment of the present inventive concept is to provide improvements over known art. This object may be achieved by a technique defined herein.

In a first aspect of the present disclosure there is provided a method for manufacturing a building panel, such as a floor panel or wall panel, comprising:
joining a substrate material and a sublayer material to form a substrate and a sublayer of the building panel, wherein the sublayer material comprises a polymer-based material,
applying a surface layer on the sublayer,
applying pressure to form said building panel, and
forming a bevel along at least one edge of the building panel by applying pressure means of a pressing device,
wherein the sublayer is configured to be at least partly plastically deformed when pressure is applied in order to at least form the bevel of the building panel.

In one embodiment, the step of applying pressure by the pressing device to form the bevel may be performed subsequent to applying pressure to form the building panel. Applying pressure to form the building panel may be separate from applying pressure to form the bevel.

In one embodiment, applying pressure to form the building panel may take place substantially simultaneously as forming the bevel by applying pressure. Applying pressure to form the bevel and applying pressure to form the building panel may take place in one pressing operation.

The pressure applied when forming the building panel may be 5-20 bar.

The substrate material and the sublayer material may be joined when applying pressure to form the building panel.

The surface layer may be adhered to the sublayer when pressure is applied to form the building panel.

By forming the bevel by plastic deformation in the sublayer, bevels may be formed in highly filled substrates. Further, plastic deformation in the sublayer at least partly reduces the amount of surface material required to form the bevel.

In an embodiment the step of applying pressure to form the building panel further comprises applying heat.

The temperature applied when forming the building panel may be 120-160° C.

In another embodiment the step of forming a bevel along at least one edge portion of the building panel by means of a pressing device, further comprises applying heat.

In an embodiment the temperature in the material when forming the bevel is 40-220° C., or 75-180° C. and it may depend on various properties, such as the thickness of the material, the type of material.

In an embodiment the pressure used to form the bevel is 1-50 bar or 1-30 bar, or 1-20 bar. The pressure applied may depend on the temperature in the material when forming the bevel.

In an embodiment the joining of the substrate material and the sublayer material is made by an extrusion process. The joining of the substrate material and the sublayer material may further include a calendaring process.

In another embodiment the joining of the substrate material and the sublayer material is made by a calendering process.

In yet another embodiment the joining of the substrate material and the sublayer material is made by a pressing process, preferably a continuous pressing process.

In an embodiment the step of applying pressure to form the building panel is made by a continuous pressing device in which the building panel may be continuously transported in a direction through the continuous pressing device.

In an alternative embodiment the step of applying pressure to form the building panel is made by a static pressing device in which the building panel may be placed under and/or above the static pressing device, kept there during the pressing time and removed after the pressing process.

Further, the pressing device for forming the bevel may be a singular pressing device or a multiple pressing device, a static pressing device, or a continuous pressing device.

The pressing device for forming the bevel may be provided with a protruding part, configured to form the bevel during pressing.

The bevel may have any shape, such as V-shaped, U-shaped or arc-shaped. The bevel may be formed in the surface layer, and preferably also in the sub-layer, in a direction substantially perpendicular to a plane defined by the front surface of the building panel.

The shape and dimensions of the bevel may depend on the thickness of the building panel and/or the total thickness of the surface layer and sublayer. In an embodiment the shape and dimensions of the bevel may depend on the dimensions and location of a mechanical locking device as described in more detail below.

The bevel may, in a direction perpendicular to the plane defined by the front surface of the building panel, extends between 0.2 mm and 1 mm. In an embodiment where the building panel has a thinner thickness, e.g., between 2 mm. and 5 mm., the bevel may preferably extend between 0.2 mm. and 0.5 mm. in the direction perpendicular to the front surface of the building panel. In another embodiment where the building panel has a thicker thickness, e.g., between 5 mm. and 10 mm., the bevel may preferably extend between 0.5 mm. and 1 mm. in the direction perpendicular to the front surface of the building panel.

The bevel may further be curved with a radius of between 1 mm. and 10 mm.

The bevel may even further, as explained above, depend on the mechanical locking device. In an embodiment the mechanical locking device extends, in a direction parallel to the plane defined by the front surface of the building panel and into the building panel, further than the bevel does. In an embodiment a tongue groove of the mechanical locking device extends, in a direction parallel to the plane defined by the front surface of the building panel and into the building panel, further than the bevel does. In another embodiment a locking groove of the mechanical locking device extends, in a direction parallel to the plane defined by the front surface of the building panel and into the building panel, further than the bevel does.

In an embodiment the pressing device for forming the bevel may be configured to press a pattern or a structure into the bevel during the forming of such. E.g. it may be desirable to have an embossing in the bevel following a specific pattern in a decorative layer of the surface layer for e.g. enhancing the decorative properties of the decorative layer in the bevel. Such an embossing may, e.g., form depressions and/or elevations with a pressing occurring within a temperature range of 10-300° C., such as 50-220° C., such as 75 and 180° C. and with pressure range of 1-100 bar, such as 1-50 bar, such as 1-30 bar, for a time period of 0.1-500 seconds, such as 0.5-300 seconds, such as 1-60 seconds.

The method may then further comprise a cooling process after forming the bevel and/or the building panel. By adding the step of cooling it may become easier to control the elasticity and/or recovery effect of the material/s in the bevel and/or the building panel and in turn control the final appearance of the bevel of the building panel. A further advantage of having a cooling step is that it may provide a broader range of materials which can be used for the building panel, as different material may be prone to elastically go back and/or recover at different temperatures and by adding cooling the elasticity and/or recovery process may be stopped.

The cooling process is preferably an active process in order to shorten the time compared to letting the temperature in the material decrease by means of the surrounding environment. The cooling process may be achieved by a cooling device using air, liquid, gas, solid materials and/or other suitable means. The cooling device may perform the cooling through, e.g., blowing, spraying, evaporation and/or through contact.

The cooling process may be configured to decrease the temperature, in the area of the material where the bevel is formed, between 15% and 40%. Depending on the type of cooling the cooling device uses and the temperature of such cooling the time spent by the cooling process may vary. For example, if cold water is used the cooling process may take between 2 sec. and 20 sec., and if cold air is used the cooling process may take between 30 sec. and 2 min, all depending on the type of cooling and the temperature.

In an embodiment the polymer-based material of the sublayer material forming the sublayer is a thermoplastic material.

The thermoplastic material of the sublayer material may be chosen from a group comprising: polyvinyl chloride (PVC), polyethylene terephthalate (PET), polyvinyl butyral (PVB), polybutylene terephthalate (PBT), polyethylene (PE), polystyrene (PS), polypropylene (PP), polycarbonate (PC), polyvinyl acetate (PVAc), ethylene-vinyl acetate (EVA), polyacrylate methacrylate, polymethylmethacrylate (PMMA), acrylonitrile butadiene styrene (ABS), thermoplastic polyurethane (TPU), and/or a combination thereof.

The sublayer material may comprise an amount of at least 10 wt %, at least 15 wt % or at least 20 wt % of the polymer-based material, such as the thermoplastic material.

The sublayer material may comprise an amount of 10-95 wt %, 15-85 wt %, or 20-70 wt % of the polymer-based material, such as the thermoplastic material.

In an embodiment the sublayer material may comprise at least one filler.

The filler of the sublayer material may comprise at least one or more of an organic filler, an inorganic filler, or a combination thereof. Fillers have the advantage of, e.g., improving layer properties and being cost efficient.

Examples of organic fillers are fibres of coconut or bamboo, wood flour and rice husks. These types of organic fillers are often cost efficient and easy to get hold of. The sublayer may comprise 1-70 wt % organic filler, or 30-70 wt % organic filler.

Examples of inorganic fillers are calcium carbonate (CaCO3), barium sulphate (BaSO4), talc, and/or a combination thereof. These types of fillers are especially cost efficient and easy to get a hold of.

In an embodiment the sublayer material comprises a mineral-based filler.

The sublayer material may comprise an amount of 1-80 wt % of the mineral based filler.

The sublayer material may comprise an amount of at least 20 wt %, or 30 wt % mineral based filler.

The mineral-based filler of the sublayer material may be calcium carbonate (CaCO₃) barium sulphate (BaSO₄), talc, gas containing elements such as glass bubbles, and/or a combination thereof.

Further, the sublayer material may comprise plastisol. A plastisol is a composition of PVC particles suspended in a plasticizer. The plastisol may further include, usually in minor amounts, extenders, stabilizers, pigments and/or fillers. The ratio between the PVC particles and the plasticizer may preferably be 50/50 by weight.

In an embodiment the sublayer material consists of plastisol.

Plastisol gives the sublayer soft and durable properties. The sublayer may be formed from a plastisol.

The sublayer material is configured to be at least partly plastically deformable when pressure is applied in order to at least form the bevel of the building panel. In order to make the sublayer material plastically deformable the material may either include a plasticizer or include at least two different types of polymers as described below.

Thus, the sublayer material may comprise a plasticizer, chosen from any of the groups of ortho-phthalates, terephthalates, aliphatics, cyclohexanoates, adipates, trimellitates, polyol esters and others, such as DOTP (dioctyl terephthalate), DEHP, DOA, DINP, DOP, ATBC, TOTM or Pevalen®. The sublayer material forming the sublayer may comprise a plasticizer of an amount of 1-30 wt %, or 2-15 wt %. A plasticizer provides the sublayer with desirable formable properties.

An alternative way of creating the desirable formable properties of the sublayer material is for the sublayer material to comprise at least two different types of polymers. For example the sublayer may comprise a material blend comprising a PVC/PVAc co-polymer, where the PVAc content in the material blend of the sublayer may be 1-20 wt % and the PVC content in the material blend may be 80-99 wt %.

In yet another embodiment the sublayer material comprises less than 10 wt % wood-based material, or less than 5 wt % wood-based material, such as 0.5-10 wt %.

The sublayer may have a thickness of 0.1-2 mm, a thickness of 0.2-1 mm, or a thickness of 0.3-1 mm.

The sublayer may have a density of between 1.0 and 2.5 g/cm³. For example, if the sublayer comprises a plastisol the density of the sublayer may be as low as 1.0-1.4 g/cm³.

In an embodiment the sublayer is foamed. The sublayer may be foamed and have a reduced density of at least 10%, at least 20% or at least 30% compared to a non-foamed sublayer of the same sublayer material. An advantage with a foamed sublayer is that it may reduce the weight of the layer. Further, a foamed sublayer material is not able to spring back after forming, e.g., a bevel, to the degree as a non-foamed sublayer material.

The substrate may in an embodiment be a single layer substrate and in another embodiment be a multi-layered substrate.

In an embodiment the substrate material forming the substrate may comprise a polymer-based material and a filler.

The polymer-based material of the substrate material may be a thermoplastic material, where the thermoplastic material may be chosen from a group comprising: polyvinyl chloride (PVC), polyethylene terephthalate (PET), polyvinyl butyral (PVB), polybutylene terephthalate (PBT), polyethylene (PE), polystyrene (PS), polypropylene (PP), polycarbonate (PC), polyvinyl acetate (PVAc), ethylene-vinyl acetate (EVA), polyacrylate methacrylate, polymethylmethacrylate (PMMA), acrylonitrile butadiene styrene (ABS), thermoplastic polyurethane (TPU), and/or a combination thereof.

The substrate material may comprise an amount of at least 10 wt %, at least 15 wt % or at least 20 wt % of the polymer-based material, such as the thermoplastic material.

The substrate material may comprise an amount of 10-60 wt %, 15-50 wt %, or 20-30 wt % of a polymer-based material, such as a thermoplastic material.

It is also possible for the substrate material to comprise thermoset material such as epoxy, polyurethane, cross-linked polyethylene (PEX), amino plastics, phenolic plastics, acrylates and/or a combination thereof.

A substrate material based on a thermoset material may include 10-70 wt %, 20-60 wt % or 25-50 wt % of a thermoset resin, such as aminoplastics, polyurethanes, phenoplastics, epoxy or acrylics.

Such substrate material may further include 0-70 wt %, 10-70 wt % or 20-70 wt % of a filler, such as an inorganic filler.

If may further be possible for the substrate material to comprise mineral based material such as magnesium oxide (MgO), magnesium chloride (MgCl2), magnesium sulfate (MgSO4), or sand. A substrate material based on these types of mineral materials may further include 1-20 wt % or 5-15 wt % filler, such as an organic filler e.g. fibres of coconut or bamboo or rice husk.

Another type of suitable mineral based material is e.g. Portland cement. A substrate material based on this type of mineral material may be called a fibre cement board, may further include sand and/or 1-20 wt % or 5-15 wt % filler, such as an organic filler.

A substrate material based on a mineral based material may include at least 50 wt %, at least 60 wt %, at least 70 wt %, or at least 80 wt % of the mineral based material. The filler of the substrate material may comprise at least one or more of an organic filler, an inorganic filler, or a combination thereof.

Examples of organic fillers are fibres of coconut or bamboo and rice husks. These types of organic fillers are often cost efficient and easy to get hold of. The substrate may comprise 1-70 wt % organic filler, e.g., 30-70 wt % organic filler.

Examples of inorganic fillers are calcium carbonate (CaCO3), barium sulphate (BaSO4), talc, and/or a combination thereof. These types of fillers are especially cost efficient and easy to get a hold of.

In an embodiment the substrate material comprises a mineral-based filler.

The substrate material may comprise an amount of 30-90 wt % of the mineral based filler.

The mineral-based filler of the substrate material may be calcium carbonate (CaCO₃) barium sulphate (BaSO₄), talc, gas containing elements such as glass bubbles, and/or a combination thereof.

The substrate may further comprise a plasticizer, chosen from any of the groups of ortho-phthalates, terephthalates, aliphatics, cyclohexanoates, adipates, trimellitates, polyol esters and others, such as DOTP (dioctyl terephthalate), DEHP, DOA, DINP, DOP, ATBC, TOTM or Pevalen®. The substrate material forming the substrate may comprise a plasticizer of an amount of 1-30 wt %, or 2-15 wt %.

A typical SPC substrate which may be preferred to use for this type of application, may include 10-40 wt %, 15-35 wt %, or 20-30 wt % of a thermoplastic material, such as PVC. The SPC core may further include 50-90 wt %, 60-80 wt % or 65-75 wt % of an inorganic filler, such as chalk. The SPC core may further include 0-20 wt %, 1-15 wt % or 2-10 wt % of additives, such as impact modifier, stabilizer, lubricant and/or pigment.

A typical LVT substrate, which also may be preferred to use for this type of application, would have a similar content of material as the SPC substrate above, i.e. 10-40 wt %, 15-35 wt %, or 20-30 wt % of a thermoplastic material, 50-90 wt %, 60-80 wt % or 65-75 wt % of an, usually, inorganic filler and 0-20 wt %, 1-15 wt % or 2-10 wt % of additives, but with the addition of 1-20 wt %, 2-15 wt % or 3-10 wt % of a plasticizer.

In an embodiment the substrate material comprises less than 10 wt % wood-based material, or less than 5 wt % wood-based material, such as 0.5-10 wt %.

In an embodiment the surface layer may comprise a decorative layer. The decorative layer may be a coloured powder layer, a paper sheet, a polymer-based sheet, a wood-based sheet, a wood veneer, a cork-based sheet or a fabric, woven or non-woven.

In an embodiment the surface layer comprises a decorative layer comprising a printed polymer-based sheet.

Further, the surface layer may comprise a wear layer, such as a wear resistant foil, a wear layer having wear resistant particles and/or a lacquered layer and/or coating layer.

The method may further comprise:
creating an indentation in an edge portion of the at least one edge of the building panel prior to forming the bevel along the at least one edge of the building panel by means of a pressing device.

The step of creating an indentation in an edge portion may be made by a milling process or any other process suitable for removing material.

In an embodiment the indentation may be located in a back portion of the building panel. The indentation may be located in a back surface of the building panel, opposite the surface layer.

In alternative embodiments the indentation may be located at a distance from a surface of the building panel, in a direction perpendicular to the surface of the building panel. If the surface is the front surface of the building panel the distance from the surface of the building panel may preferably correspond to at least the thickness of a wear layer, if any wear layer is present, or correspond at least to the thickness of the surface layer of the building panel. In an embodiment, the indentation is arranged in the substrate of the building panel. In an alternative embodiment, the indentation is arranged partly in the substrate and partly in the surface layer.

Further, the indentation may extend in a direction parallel to a front surface and/or back surface of the building panel and parallel to the extension of the edge in which the indentation is created. In an embodiment the indentation extends along the entire length of the edge of the building panel in which it is created.

Features and dimensions of the indentations may vary depending on e.g. the material of the layer in which it is created, the intended dimensions of the bevel or on the intended calibrating process, e.g., if the building panel should include a mechanical locking device.

The indentation may preferably extend, in a direction parallel to the plane defining the front surface of the building panel and into the building panel, the same length as or further than the extension of the intended bevel to be formed.

In an embodiment where a mechanical locking device is to be formed in the building panel, the indentation may preferably extend, in a direction parallel to the plane defining the front surface of the building panel and into the building panel, no further than the mechanical locking device, or even more preferred shorter that then mechanical locking device.

In another embodiment a tongue groove, to be formed, of the mechanical locking device extends, after it has been formed, in a direction parallel to the plane defined by the front surface of the building panel and into the building panel, further than the indentation does. In yet another embodiment a locking groove, to be formed, of the mechanical locking device extends, after is has been formed, in a direction parallel to the plane defined by the front surface of the building panel and into the building panel, further than the indentation does. This is preferred since the indentations should not affect either the process of forming the mechanical locking device or the dimensions of such mechanical locking device. Thus, the remaining indentations, after the bevel has been formed, are preferably to be removed during the forming of the mechanical locking device.

In fact, regardless of the final process steps along the edges of the building panel, e.g., calibrating, the remaining indentations, after the bevel has been formed, are preferably to be removed during such final process step. Thus, the indentations may preferably be temporary features of the edge of the building panel which during a final shaping process i.e. a calibrating process, is no longer present in its original shape.

In an embodiment the height of the opening of the indentation, prior to forming the bevel, is about equal to the height of the bevel.

In another embodiment the height of the opening of the indentation, prior to forming the bevel, exceeds the height of the bevel.

In an embodiment the length, in the direction parallel to the front surface of the building panel and into the building panel, of the indentation is about equal to the radius of the bevel.

In an embodiment the length, in the direction parallel to the front surface of the building panel and into the building panel, of the indentation exceeds the radius of the bevel.

The method may further comprise:
heating at least an area between the indentation and the surface of the building panel prior to forming the bevel along the at least one edge of the building panel. The area may comprise portions of the surface layer located at the edge of the building panel in which the indentation is created. Alternatively, the area may comprise portions of the surface layer and portions of the substrate located at the edge of the building panel in which the indentation is created.

In an embodiment the thickness of the area which is heated prior to forming the bevel may correspond to the distance from the surface of the building panel, in the direction perpendicular to the surface of the building panel, at which the indentation is created.

The method may further comprise:
calibrating at least one edge of the building panel after forming the bevel along the at least one edge of the building panel. Calibrating an edge of the building panel may include making finishing process steps to create the final shape and tolerances of the edges, the bevel, and the building panel. Such finishing process steps could be achieved by, e.g., cutting, milling and/or abrasive.

In an embodiment the step of calibrating the edge may include creating an edge surface substantially perpendicular to the front surface of the building panel. Such calibrating could be achieved by, e.g., cutting, milling and/or abrasive.

In an alternative embodiment the step of calibrating the edge may include creating an angled edge surface, where an edge of the front surface preferably protrudes out from a plane, arranged in the edge of the back surface, extending perpendicular to the front surface. I.e. the angled surface is preferably angled towards the rest of the building panel, from the front surface to the back surface of the building panel.

In an embodiment the edge surface created by the calibrating step may be a continuous surface or a discontinuous surface comprising several sections.

The method may further comprise:
creating a mechanical locking device along at least one edge of the building panel, where the mechanical locking device is configured for horizontal and/or vertical locking of similar or essentially identical building panel in an assembled position.

Creating the mechanical locking device may be seen as a further example of calibrating the edge of the building panel.

The mechanical locking device may be arranged along the edges of the building panel. The mechanical locking device may include connecting means such that similar or essentially identical building panels may be locked together. Further, each edge may be provided with similar or different types of connecting means. Preferably, the connecting means arranged on opposite edges of the building panels are compatible with each other. The mechanical locking device may be provided with a first pair of connecting means and a second pair of connecting means. For example, the connecting means of the first pair may be arranged along a first edge and an opposite second edge of the building panel, being compatible with each other. The connecting means of the second pair may be arranged along a third edge and an opposing fourth edge of the building panel, being compatible with each other. In an embodiment the first and second edge may be the long sides of a building panel having a rectangular shape, and the third and fourth edge may be the short sides of such a building panel.

The first pair of connecting means and the second pair of connecting means may be of the same type or be two different types of mechanical locking devices.

In a second aspect of the inventive concept there is provided a method manufacture a building panel, such as a floor panel or wall panel, comprising
joining a substrate material and a sublayer material to form a substrate and a sublayer of a panel board, wherein the sublayer material comprises at least a polymer-based material,
applying a surface layer on the sublayer,
applying pressure to form the panel board,
forming a groove in said panel board by applying pressure by means of a pressing device and by plastic deformation of the sublayer, and
forming a building panel out of the panel board,
wherein said groove is configured to form a bevel along at least one edge of the building panel.

In one embodiment, applying pressure to form the panel board may take place substantially simultaneously as forming the bevel by applying pressure. Applying pressure to form the bevel and applying pressure to form the panel board may take place in one pressing operation.

The pressure applied when forming the panel board may be 5-20 bar.

The substrate material and the sublayer material may be joined when applying pressure to form the panel board.

The surface layer may be adhered to the sublayer when pressure is applied to form the panel board.

The method as defined above is advantageous at least for the following reasons. By forming the groove by plastic deformation in the sublayer, grooves may be formed in highly filled substrates. Further, plastic deformation in the sublayer at least partly reduces the amount of surface material required to form the groove.

In an embodiment the sublayer material may further comprise at least one filler.

In an embodiment the step of applying pressure to at least form the panel board further comprises applying heat.

The temperature applied when forming the panel board may be 120-160° C.

In another embodiment the step of applying pressure to at least form the groove in the panel board further comprises applying heat.

In an embodiment the joining of the substrate material and the sublayer material is made by an extrusion process. The joining of the substrate material and the sublayer material may further include a calendaring process.

In another embodiment the joining of the substrate material and the sublayer material is made by a pressing process.

In an embodiment, forming the groove in the panel board is done simultaneously as forming said panel board.

In another embodiment the step of forming a groove in the panel board further comprises applying heat.

In an embodiment the temperature in the material when forming the bevel is 40-220° C., or 75-180° C. and it may depend on various properties, such as the thickness of the material, the type of material.

In an embodiment the pressure used to form the groove is 1-50 bar or 5-30 bar.

In an alternative embodiment, forming the groove in the panel board and forming the panel board is done in separate pressing processes, where preferably forming the groove is achieved after forming the panel board.

The step of applying pressure to form the panel board may, in an embodiment, be made by a continuous pressing device in which the building panel may be continuously transported at a pace in a direction through the continuous pressing device.

In an alternative embodiment the step of applying pressure to form the panel board is made by a static pressing device in which the panel board may be placed in the static pressing device, kept there during the pressing time, and removed after the pressing process.

Further, the pressing device, either a continuous pressing device or a static pressing device, may comprise at least one protruding part configured to form the groove in the panel board. In an embodiment the pressing device may comprise several protruding parts in order to simultaneously press several grooves in the panel board.

The groove may have any shape, such as V-shaped, U-shaped or circular. The groove may extend into the surface layer, and preferably into the sublayer, in a direction substantially perpendicular to a plane formed by the front surface of the panel board.

In an embodiment the pressing device for forming the groove may be configured to press a pattern or a structure into the groove during the forming of such. E.g. it may be desirable to have an embossing in the groove, and in turn in the bevel of the finished building panel, following a specific pattern in a decorative layer of the surface layer for e.g. enhancing the decorative properties of the decorative layer in the bevel.

Such an embossing may, e.g., form depressions and/or elevations with a pressing occurring within a temperature range of 10-300° C., such as 50-220° C., such as 75 and 180° C. and with pressure range of 1-100 bar, such as 1-50 bar, such as 1-30 bar, for a time period of 0.1-500 seconds, such as 0.5-300 seconds, such as 1-60 seconds.

The method may then further comprise cooling after forming the groove and/or after forming the panel board. By adding the step of cooling it may become easier to control the elasticity and/or recovery effect of the material/s in the groove and/or panel board and in turn control the final appearance of the bevel of the building panel. A further advantage of having a cooling step is that it may provide a broader range of materials which can be used for the building panel, as different material may be prone to elastically go back and/or recover at different temperatures and by adding cooling the elasticity and/or recovery process may be stopped.

The cooling process is preferably an active process in order to shorten the time compared to letting the temperature in the material decrease by means of the surrounding environment. The cooling process may be achieved by a cooling device using air, liquid, gas, solid materials and/or other suitable means. The cooling device may perform the cooling through, e.g., blowing, spraying, evaporation and/or through contact.

The cooling process may be configured to decrease the temperature, in the area of the material where the bevel is formed, between 15% and 40%. Depending on the type of cooling the cooling device uses and the temperature of such cooling the time spent by the cooling process may vary. For example, if cold water is used the cooling process may take between 2 sec. and 20 sec., and if cold air is used the cooling process may take between 30 sec. and 2 min, all depending on the type of cooling and the temperature.

In an embodiment, the step of forming the building panel out of said panel board comprises dividing the panel board into building panels at the groove. Thereby, the groove will form a bevel of the building panel along the edge.

In an embodiment the polymer-based material of the sublayer material forming the sublayer is a thermoplastic material.

The thermoplastic material of the sublayer material may be chosen from a group comprising: polyvinyl chloride (PVC), polyethylene terephthalate (PET), polyvinyl butyral (PVB), polybutylene terephthalate (PBT), polyethylene (PE), polystyrene (PS), polypropylene (PP), polycarbonate (PC), polyvinyl acetate (PVAc), ethylene-vinyl acetate (EVA), polyacrylate methacrylate, polymethylmethacrylate (PMMA), acrylonitrile butadiene styrene (ABS), thermoplastic polyurethane (TPU), and/or a combination thereof.

The sublayer material may comprise an amount of at least 10 wt %, at least 15 wt % or at least 20 wt % of the polymer-based material, such as the thermoplastic material.

The sublayer material may comprise an amount of 10-95 wt %, 15-85 wt %, or 20-70 wt % of the polymer-based material, such as the thermoplastic material.

The filler of the sublayer material may comprise at least one or more of an organic filler, an inorganic filler, or a combination thereof. Fillers have the advantage of, e.g., improving layer properties and being cost efficient.

Examples of organic fillers are fibres of coconut or bamboo, wood flour and rice husks. These types of organic fillers are often cost efficient and easy to get hold of. The sublayer may comprise 1-70 wt % organic filler, or 30-70 wt % organic filler.

Examples of inorganic fillers are calcium carbonate (CaCO3), barium sulphate (BaSO4), talc, and/or a combination thereof. These types of fillers are especially cost efficient and easy to get a hold of.

In an embodiment the sublayer material comprises a mineral-based filler.

The sublayer material may comprise an amount of 1-80 wt % of the mineral based filler.

The sublayer material may comprise an amount of at least 20 wt %, or 30 wt % mineral based filler.

The mineral-based filler of the sublayer material may be calcium carbonate (CaCO₃) barium sulphate (BaSO₄), talc, gas containing elements such as glass bubbles, and/or a combination thereof.

Further, the sublayer material may comprise plastisol. A plastisol is a composition of PVC particles suspended in a plasticizer. The plastisol may further include, usually in minor amounts, extenders, stabilizers, pigments and/or fillers. The ratio between the PVC particles and the plasticizer may preferably be 50/50 by weight.

In an embodiment the sublayer material consists of plastisol.

Plastisol gives the sublayer soft and durable properties. The sublayer may be formed of a plastisol.

The sublayer material is configured to be at least partly plastically deformable when pressure is applied in order to at least form the groove of a panel board. In order to make the sublayer material plastically deformable the material may either include a plasticizer or include at least two different types of polymers as described below.

Thus, the sublayer material may comprise a plasticizer, chosen from any of the groups of ortho-phthalates, terephthalates, aliphatics, cyclohexanoates, adipates, trimellitates, polyol esters and others, such as DOTP (dioctyl terephthalate), DEHP, DOA, DINP, DOP, ATBC, TOTM or Pevalen®. The sublayer material forming the sublayer may comprise a plasticizer of an amount of 1-30 wt %, or 2-15 wt %. A plasticizer provides the sublayer with desirable formable properties.

In another embodiment the sublayer material comprises at least two different types of polymers. For example the sublayer may comprise a material blend comprising a PVC/PVAc co-polymer, where the PVAc content in the material blend of the sublayer may be 1-20 wt % and the PVC content in the material blend may be 80-99 wt %.

In yet another embodiment the sublayer material comprises less than 10 wt % wood-based material, or less than 5 wt % wood-based material.

The sublayer may have a thickness of 0.1-2 mm, a thickness of 0.2-1 mm, or a thickness of 0.3-1 mm.

The sublayer may have a density of between 1.0 and 2.5 g/cm³. For example, if the sublayer comprises a plastisol the density of the sublayer may be as low as 1.0-1.4 g/cm³.

In an embodiment the sublayer is foamed. The sublayer may be foamed and have a reduced density of at least 10%, at least 20% or at least 30% compared to a non-foamed sublayer of the same sublayer material. An advantage with a foamed sublayer is that it may reduce the weight of the layer. Further, a foamed sublayer material is not able to spring back after forming, e.g., a bevel, to the degree as a non-foamed sublayer material.

The substrate may in an embodiment be a single layer substrate and in another embodiment be a multi-layered substrate.

In an embodiment the substrate material forming the substrate comprises a polymer-based material and a filler.

The polymer-based material of the substrate material may be a thermoplastic material, where the thermoplastic material may be chosen from a group comprising: polyvinyl chloride (PVC), polyethylene terephthalate (PET), polyvinyl butyral (PVB), polybutylene terephthalate (PBT), polyethylene (PE), polystyrene (PS), polypropylene (PP), polycarbonate (PC), polyvinyl acetate (PVAc), ethylene-vinyl acetate (EVA), polyacrylate methacrylate, polymethylmethacrylate (PMMA), acrylonitrile butadiene styrene (ABS), thermoplastic polyurethane (TPU), and/or a combination thereof.

The substrate material may comprise an amount of at least 10 wt %, at least 15 wt % or at least 20 wt % of the polymer-based material, such as the thermoplastic material.

The substrate material may comprise an amount of 10-60 wt %, 15-50 wt %, or 20-30 wt % of a polymer-based material, such as a thermoplastic material.

It is also possible for the substrate material to comprise thermoset material such as epoxy, polyurethane, cross-linked polyethylene (PEX), amino plastics, phenolic plastics, acrylates and/or a combination thereof.

A substrate material based on a thermoset material may include 10-70 wt %, 20-60 wt % or 25-50 wt % of a thermoset resin, such as aminoplastics, polyurethanes, phenoplastics, epoxy or acrylics. Such substrate material may further include 0-70 wt %, 10-70 wt % or 20-70 wt % of a filler, such as an inorganic filler.

If may further be possible for the substrate material to comprise mineral based material such as magnesium oxide (MgO), magnesium chloride (MgCl2), magnesium sulfate (MgSO4), or sand. A substrate material based on these types of mineral materials may further include 1-20 wt % or 5-15 wt % filler, such as an organic filler e.g. wood fibres.

Another type of suitable mineral based material is e.g. Portland cement. A substrate material based on this type of mineral material may be called a fibre cement board, may further include sand and/or 1-20 wt % or 5-15 wt % filler, such as an organic filler.

A substrate material based on a mineral based material may include at least 50 wt %, at least 60 wt %, at least 70 wt %, or at least 80 wt % of the mineral based material.

The filler of the substrate material may comprise at least one or more of an organic filler, an inorganic filler, or a combination thereof.

Examples of organic fillers are fibres of coconut or bamboo and rice husks. These types of organic fillers are often cost efficient and easy to get hold of. The substrate may comprise 1-70 wt % organic filler, or 30-70 wt % organic filler.

Examples of inorganic fillers are calcium carbonate (CaCO3), barium sulphate (BaSO4), talc, and/or a combination thereof. These types of fillers are especially cost efficient and easy to get a hold of.

In an embodiment the substrate material comprises a mineral-based filler.

The substrate material may comprise an amount of 30-90 wt % of the mineral based filler.

The mineral-based filler of the substrate material may be calcium carbonate (CaCO₃).

The substrate may further comprise a plasticizer, chosen from any of the groups of ortho-phthalates, terephthalates, aliphatics, cyclohexanoates, adipates, trimellitates, polyol esters and others, such as DOTP (dioctyl terephthalate), DEHP, DOA, DINP, DOP, ATBC, TOTM or Pevalen®. The substrate material forming the substrate may comprise a plasticizer of an amount of 1-30 wt %, or 2-15 wt %.

A typical SPC substrate which may be preferred to use for this type of application, may include 10-40 wt %, 15-35 wt %, or 20-30 wt % of a thermoplastic material, such as PVC. The SPC core may further include 50-90 wt %, 60-80 wt % or 65-75 wt % of an inorganic filler, such as chalk. The SPC core may further include 0-20 wt %, 1-15 wt % or 2-10 wt % of additives, such as impact modifier, stabilizer, lubricant and/or pigment.

A typical LVT substrate, which also may be preferred to use for this type of application, would have a similar content of material as the SPC substrate above, i.e., 10-40 wt %, 15-35 wt %, or 20-30 wt % of a thermoplastic material, 50-90 wt %, 60-80 wt % or 65-75 wt % of an inorganic filler and 0-20 wt %, 1-15 wt % or 2-10 wt % of additives, but with the addition of 1-20 wt %, 2-15 wt % or 3-10 wt % of a plasticizer.

In an embodiment the substrate material comprises less than 10 wt % wood-based material, or less than 5 wt % wood-based material.

In an embodiment the surface layer may comprise a decorative layer. The decorative layer may be a coloured powder layer, a paper sheet, a polymer-based sheet, a wood-based sheet, a wood veneer, a cork-based sheet or a fabric, woven or non-woven.

In an embodiment the surface layer comprises a decorative layer comprising a printed polymer-based sheet.

Further, the surface layer may comprise a wear layer, such as a wear resistant foil, a wear layer having wear resistant particles and/or a lacquered layer and/or a coating.

In an embodiment the method further comprises:
calibrating at least one edge of the building panel after forming the building panel out of said panel board. Calibrating an edge of the building panel may include making finishing process steps to create the final shape and tolerances of the edges and the building panel. Such finishing process steps could be achieved by, e.g., cutting, milling and/or abrasive.

In an embodiment the step of calibrating the edge may include creating an edge surface substantially perpendicular to the front surface of the building panel. Such calibrating could be achieved by, e.g., cutting, milling and/or abrasive.

In an alternative embodiment the step of calibrating the edge may include creating an angled edge surface, where an edge of the front surface preferably protrudes out from a plane, arranged in the edge of the back surface, extending perpendicular to the front surface. I.e. the angled surface is preferably angled towards the rest of the building panel, from the front surface to the back surface of the building panel.

In an embodiment the edge surface created by the calibrating step may be a continuous surface or a discontinuous surface comprising several sections.

The method may further comprise:
creating a mechanical locking device along at least one edge of the building panel after forming the building panel out of said panel board, where the mechanical locking device is configured for horizontal and/or vertical locking of similar or essentially identical building panel in an assembled position.

Creating the mechanical locking device may be seen as a further example of calibrating the edge of the building panel.

The mechanical locking device may be arranged along the edges of the building panel. The mechanical locking device may include connecting means such that similar or essentially identical building panels may be locked together. Further, each edge may be provided with similar or different types of connecting means. Preferably, the connecting means arranged on opposite edges of the building panels are compatible with each other. The mechanical locking device may be provided with a first pair of connecting means and a second pair of connecting means. For example, the connecting means of the first pair may be arranged along a first edge and an opposite second edge of the building panel 1, being compatible with each other. The connecting means of the second pair may be arranged along a third edge and an opposing fourth edge of the building panel, being compatible with each other. In an embodiment the first and second edge may be the long sides of a building panel having a rectangular shape, and the third and fourth edge may be the short sides of such a building panel.

The first pair of connecting means and the second pair of connecting means may be of the same type or be two different types of mechanical locking devices.

In a third aspect of the inventive concept there is provided a building panel manufactured by any one of the methods defined above.

In a fourth aspect of the inventive concept there is provided a method to form a bevel along at least one edge of a building panel, comprising:
forming a building panel comprising a substrate, a sublayer, and a surface layer, wherein the sublayer is arranged between the substrate and the surface layer, and wherein the sublayer comprises a polymer-based material, and forming a bevel along at least one edge of the building panel by plastic deformation of the sublayer.

In an embodiment forming the bevel along at least one edge of the building panel by plastic deformation of the sublayer comprises applying pressure by a pressing device.

In another embodiment forming the building panel comprises joining the substrate, the sublayer, and the surface layer by applying pressure to form the building panel.

Applying pressure by the pressing device to form the bevel may be made subsequent to applying pressure to form the building panel (1).

In a fifth aspect of the present inventive concept there is provided a method to form a bevel along at least one edge of a building panel, comprising
forming a panel board comprising a substrate, a sublayer, and a surface layer, wherein the sublayer is arranged between the substrate and the surface layer, and wherein the sublayer comprises a polymer-based material, and
forming a groove in the panel board by plastic deformation of the sublayer,
forming at least one building panel out of the panel board, and
wherein the groove is configured to form a bevel along at least one edge of said at least one building panel.

In an embodiment forming the groove along at least one edge of the building panel by plastic deformation of the sublayer comprises applying pressure by a pressing device.

In another embodiment forming the panel board comprises joining the substrate, the sublayer, and the surface by applying pressure to form the panel board.

Applying pressure by the pressing device to form the groove may be made subsequent to applying pressure to form the building panel.

Further, forming the building panel out of said panel board may comprise cutting said panel board at the groove.

### BRIEF DESCRIPTION OF THE DRAWINGS

Embodiments of the invention will be described in the following: reference being made to the appended drawings which illustrate non-limiting embodiments of how the inventive concept can be reduced into practice.

FIG. 1A schematically illustrates a building panel according to an embodiment of the inventive concept,

FIG. 1B schematically illustrate an alternative building panel according to an embodiment of the inventive concept,

FIG. 2 illustrates a building panel according to an embodiment of the inventive concept,

FIG. 3A illustrates an assembly of a plurality of building panels,

FIG. 3B illustrates the finished assembly of FIG. 3A,

FIG. 4A schematically illustrates a cross section of two opposite edge portions of two adjacent building panels comprising a mechanical locking device according to an embodiment of the inventive concept for locking the two building panels together, in an unassembled position,

FIG. 4B schematically illustrates a cross section of the two opposite edge portions in FIG. 4A, in an assembled position,

FIG. 4C schematically illustrates a cross section of the two opposite edge portions in FIG. 4A, during the assembly.

FIG. 5A schematically illustrates a cross section of two opposite edge portions of two adjacent building panels comprising a mechanical locking device according to another embodiment of the inventive concept for locking the two building panels together, in an unassembled position,

FIG. 5B schematically illustrates a cross section of the two opposite edge portions in FIG. 5A, in an assembled position,

FIG. 5C schematically illustrates a cross section of the two opposite edge portions in FIG. 5A, during the assembly.

FIG. 6A schematically illustrates a cross section of two opposite edge portions of two adjacent building panels comprising a mechanical locking device according to yet another embodiment of the inventive concept for locking the two building panels together, in an unassembled position,

FIG. 6B schematically illustrates a cross section of the two opposite edge portions in FIG. 6A, in an assembled position,

FIG. 6C schematically illustrates a cross section of the two opposite edge portions in FIG. 6A, during the assembly,

FIGS. 7A and 7B schematically illustrate steps of a method to produce a building panel, according to an embodiment of the inventive concept,

FIGS. 8A and 8B schematically illustrate steps of a method to produce a building panel, according to another embodiment of the inventive concept,

FIG. 9 schematically illustrates of a method to produce a building panel, according to another embodiment of the inventive concept,

FIG. 10A schematically illustrates a method to create a bevel of a building panel, according to an embodiment of the inventive concept,

FIG. 10B schematically illustrates the method in FIG. 10A from another angle,

FIG. 11 schematically illustrates a side view of a cross section of a building panel prior to creating the intended edges of a finished building panel,

FIG. 12A schematically illustrates a first step of a method to create the intended edges of a building panel, according to an embodiment of the inventive concept,

FIG. 12B is a detailed view of FIG. 12A,

FIG. 12C schematically illustrates a side view of a cross section of the building panel after the first step in FIG. 12A,

FIG. 13A schematically illustrates a second step of a method to create the intended edges of a building panel, according to an embodiment of the inventive concept,

FIG. 13B is a detailed view of FIG. 13A,

FIG. 14A schematically illustrates a third step of a method to create the intended edges of a building panel, according to an embodiment of the inventive concept,

FIG. 14B is a detailed view of FIG. 14A,

FIG. 14C illustrates a side view of a cross section of the building panel after the third step in FIG. 14A,

FIG. 15A illustrates a fourth step of a method to create the intended edges of a building panel, according to an embodiment of the inventive concept,

FIG. 15B is a detailed view of FIG. 15A,

FIG. 16A schematically illustrates a step of a calibrating method to create the intended edges of a building panel, according to an embodiment of the inventive concept,

FIG. 16B schematically illustrates a side view of a cross section of the building panel after the step in FIG. 16A,

FIG. 17A schematically illustrates a step of another calibrating method to create the intended edges of a building panel, according to an embodiment of the inventive concept,

FIG. 17B schematically illustrates a side view of a cross section of the building panel after the step in FIG. 17A,

FIG. 18A schematically illustrates a step of yet another calibrating method to create the intended edges of a building panel, according to an embodiment of the inventive concept,

FIG. 18B is a detailed view of FIG. 18A,

FIG. 18C schematically illustrates a side view of a cross section of the building panel after the step in FIG. 18A,

FIG. 19A schematically illustrates a side view of a cross section of a building panel prior to creating an alternative intended edge of a finished building panel,

FIG. 19B schematically illustrates a side view of the cross section in FIG. 19A after a step of a method to create indentations in the edges of a building panel, according to another embodiment of the inventive concept,

FIG. 19C schematically illustrates a side view of the cross section in FIG. 19A after a step of a method, following the step in FIG. 19B, to create a bevel of a building panel, according to an embodiment of the inventive concept,

FIG. 19D schematically illustrates a side view of the cross section in FIG. 19A after a step of a calibrating method, following the step in FIG. 19C, to create a mechanical locking device of a building panel, according to an embodiment of the inventive concept,

FIG. 20A schematically illustrates a first step of a method to create a building panel from a panel board, according to an embodiment of the inventive concept,

FIG. 20B schematically illustrates a side view of a cross section of the panel board in FIG. 20A,

FIG. 21A schematically illustrates a second step of a method to create a building panel from a panel board, according to an embodiment of the inventive concept,

FIG. 21B schematically illustrates a side view of a cross section of the panel board in FIG. 21A,

FIG. 22A schematically illustrates a third step of a method to create a building panel from a panel board, according to an embodiment of the inventive concept,

FIG. 22B schematically illustrates a side view of a cross section of the panel board in FIG. 22A,

FIG. 23A schematically illustrates a fourth step of a method to create a building panel from a panel board, according to an embodiment of the inventive concept,

FIG. 23B schematically illustrates a side view of a cross section of the panel board in FIG. 23A,

FIG. 24A schematically illustrates a fifth step of a method to create a building panel from a panel board, according to an embodiment of the inventive concept,

FIG. 24B schematically illustrates a side view of a cross section of the panel board in FIG. 24A,

FIG. 25 schematically illustrates the method steps of FIGS. 20-24,

FIG. 26 is a photo of a panel board according to an embodiment with pressed grooves achieved by a method according to an embodiment of the present inventive concept,

FIG. 27A is a photo of two building panels according to an embodiment after creating the intended edges, e.g. by a method illustrated in FIGS. 14A-14C,

FIG. 27B is a photo of the two building panels in FIG. 27A after cutting the edges, and

FIG. 27C is a photo of the two building panels in FIG. 27B placed adjacent each other to illustrate an assembled position.

### DETAILED DESCRIPTION OF EMBODIMENTS

Specific embodiments of the inventive concept will now be described with reference to the accompanying drawings. The inventive concept may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the inventive concept. In the drawings, like numbers refer to like elements.

Generally, in this disclosure, terms like “below” or “lower” typically implies closer to the back surface of the panel or a plane thereof, whereas “above” or “upper” implies closer to the front surface or a plane thereof. Further, the thickness direction of the panel is defined as the vertical direction when the panel lays flat on a surface. The horizontal and vertical direction are applicable definition when the building panel is lays flat on e.g. a floor. Instead of horizontal and vertical directions, the description will also refer to a direction parallel with extension of the decorative surface and a direction perpendicular to the extension of the decorative surface. When a building panel is lays flat on e.g. a floor, the horizontal direction is the same as the direction parallel with the extension of the decorative surface and the vertical direction is the same as the direction perpendicular to the extension of the decorative surface.

In this disclosure a plastically deformable sublayer is illustrated and discussed. A definition of a plastically deformable layer, used throughout this disclosure, is one where the shape of the layer may be changed under the application of heat and pressure, and the changed shape may be maintained during and after the application of heat and pressure. For example, a bevel, depressions and/or elevations, may be formed in the material of a plastically deformable layer by application of heat and pressure, and the bevel, depressions and/or elevations may be maintained during and after the application of heat and pressure. A plastically deformable layer may be considered sufficiently plastically deformable when, e.g., a depression of 0.04 mm is formed when an embossing plate with a rill of 1.2 mm depth and a base width of 2 mm is pressed against the layer at a pressure of 20 bar and a temperature of 80° C. for 35 seconds. In further embodiments, a plastically deformable layer may be considered sufficiently plastically deformable when, e.g., a depression of 0.06 mm, such as 0.08 mm, such as 0.1 mm, such as 0.12 mm is formed when an embossing plate with a rill of 1.2 mm depth and a base width of 2 mm is pressed against the layer at a pressure of 20 bar and a temperature of 80° C. for 35 seconds.

In other embodiments, a plastically deformable layer may be considered sufficiently plastically deformable when the plastically deformable layer is more plastically deformable than the substrate. That is, a deeper depression is formed in the plastically deformable layer, as compared to a depression formed in the substrate, when each are pressed with an embossing plate with a rill of 1.2 mm depth and a base width of 2 mm at a pressure of 20 bar and a temperature of 80° C. for 35 seconds. For example, the depression in the plastically deformable layer may be at least 10% deeper, such as at least 25% deeper, such as at least 50% deeper than a depression formed in the substrate when each are pressed with an embossing plate with a rill of 1.2 mm depth and a base width of 2 mm at a pressure of 20 bar and a temperature of 80° C. for 35 seconds.

A purpose of the sublayer being plastically deformable is to allow easier and/or deeper bevel forming and/or embossing of the building panel during the manufacturing process, without affecting or at least having less effect on the substrate. Thus, an advantage with the plastically deformable sublayer is that the substrate may be protected, if desirable, from the pressure of the embossing during the manufacturing process.

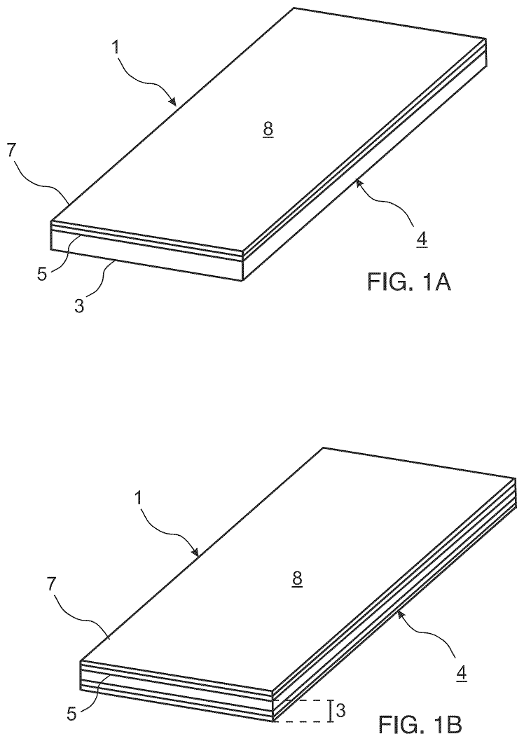

FIGS. 1A and 1B are schematic illustrations of two different types of building panels 1 having a rectangular shape. Each building panel 1 has a substrate 3, a sublayer 5 and a surface layer 7.

The substrate 3 is arranged in the back of the building panel 1. A lower side of the substrate 3 forms a back surface 4 of the building panel 1 and an upper side of the substrate 3 is attached to the sublayer 5 of the building panel 1. The building panel 1 in FIG. 1A has a single layer substrate 3 and the building panel 1 in FIG. 1B has a multi-layered substrate 3. The multi-layered substrate 3 may include two or more layers forming the substrate 3 e.g. a backing layer, a balancing layer, a reinforcement layer, a mineral-based layer, or a sound dampening layer.

The sublayer 5 is arranged in between the substrate 3 and the surface layer 7. The sublayer 5 is configured to be plastically deformable when at least pressure, preferably also heat, is applied to the sublayer 5 and/or the surface layer 7. This is advantageous when e.g. forming a bevel 10 at an edge 15, 16, 17, 18 of the building panel 1, or forming a groove 11 in a panel board 2, by means of pressing, or pressing and heating. A method for forming the pressed bevel 10 and pressed groove 11 respectively is described in more detail below.

The substrate 3 comprises a substrate material including a polymer-based material, which preferably is a thermoplastic material. The thermoplastic material may be chosen from a group comprising: polyvinyl chloride (PVC), polyethylene terephthalate (PET), polyvinyl butyral (PVB), polybutylene terephthalate (PBT), polyethylene (PE), polystyrene (PS), polypropylene (PP), polycarbonate (PC), polyvinyl acetate (PVAc), ethylene-vinyl acetate (EVA), polyacrylate methacrylate, polymethylmethacrylate (PMMA), acrylonitrile butadiene styrene (ABS), thermoplastic polyurethane (TPU), and/or a combination thereof. The substrate material may comprise an amount of at least 10 wt %, at least 15 wt % or at least 20 wt % of the thermoplastic material. For example, the sublayer material may comprise an amount of 10-95 wt %, 15-85 wt %, or 20-70 wt % of the polymer-based material, such as the thermoplastic material.

The substrate material preferably has less than 10 wt % wood-based material, or less than 5 wt % wood-based material, such as 0.5-10 wt %. A wood-based material may e.g. be wood fibres or wood chips.

The substrate material may further include at least one or more of an organic filler, an inorganic filler, or a combination thereof. Examples of organic fillers are fibres of bamboo or coconut and rice husks. These types of organic fillers are often cost efficient and easy to get hold of. The substrate may comprise 1-70 wt % organic filler, or 30-70 wt % organic filler. Examples of inorganic fillers are calcium carbonate (CaCO3), barium sulphate (BaSO4), talc, and/or a combination thereof. These types of fillers are especially cost efficient and easy to get a hold of.

The substrate material may further include a plasticizer, chosen from any of the groups of ortho-phthalates, terephthalates, aliphatics, cyclohexanoates, adipates, trimellitates, polyol esters and others, such as DOTP (dioctyl terephthalate), DEHP, DOA, DINP, DOP, ATBC, TOTM or Pevalen®. The substrate material forming the substrate may comprise a plasticizer of an amount of 1-30 wt %, or 2-15 wt %.

A typical SPC substrate which may be preferred to use for this type of application, may include 10-40 wt %, 15-35 wt %, or 20-30 wt % of a thermoplastic material, such as PVC. The SPC core may further include 50-90 wt %, 60-80 wt % or 65-75 wt % of an inorganic filler, such as chalk. The SPC core may further include 0-20 wt %, 1-15 wt % or 2-10 wt % of additives, such as impact modifier, stabilizer, lubricant and/or pigment.

A typical LVT substrate, which also may be preferred to use for this type of application, would have a similar content of material as the SPC substrate above, i.e. 10-40 wt %, 15-35 wt %, or 20-30 wt % of a thermoplastic material, 50-90 wt %, 60-80 wt % or 65-75 wt % of an inorganic filler and 0-20 wt %, 1-15 wt % or 2-10 wt % of additives, but with the addition of 1-20 wt %, 2-15 wt % or 3-10 wt % of a plasticizer.

The sublayer 5 comprises a sublayer material including a polymer-based material, preferably a thermoplastic material. The thermoplastic material of the sublayer material may be chosen from a group comprising: polyvinyl chloride (PVC), polyethylene terephthalate (PET), polyvinyl butyral (PVB), polybutylene terephthalate (PBT), polyethylene (PE), polystyrene (PS), polypropylene (PP), polycarbonate (PC), polyvinyl acetate (PVAc), ethylene-vinyl acetate (EVA), polyacrylate methacrylate, polymethylmethacrylate (PMMA), acrylonitrile butadiene styrene (ABS), thermoplastic polyurethane (TPU), and/or a combination thereof.

The sublayer material may include an amount of at least 10 wt %, at least 15 wt % or at least 20 wt % of the polymer-based material, e.g. the thermoplastic material.

The sublayer material may comprise an amount of 10-95 wt %, 15-85 wt %, or 20-70 wt % of the polymer-based material, such as the thermoplastic material.

The sublayer material is, as described above, a polymer-based material and includes less than 10 wt % wood-based material, or even less than 5 wt % wood-based material, such as 0.5-10 wt %.

The sublayer material may further comprise one or more fillers which is at least one or more of an organic filler, an inorganic filler, or a combination thereof. Fillers have the advantage of, e.g., improving layer properties and being cost efficient. Examples of organic fillers are fibres of bamboo or coconut, wood flour and rice husks. These types of organic fillers are often cost efficient and easy to get hold of. The sublayer may comprise 1-70 wt % organic filler, or 30-70 wt % organic filler. Examples of inorganic fillers are calcium carbonate (CaCO3), barium sulphate (BaSO4), talc, and/or a combination thereof. These types of fillers are especially cost efficient and easy to get a hold of.

Where the sublayer material comprises a mineral-based filler, and especially if it is calcium carbonate (CaCO₃), the sublayer material may include an amount of 1-80 wt % of such filler.

Further, the sublayer material may include a plastisol. Plastisol gives the sublayer soft and durable properties. A plastisol is a composition of PVC particles suspended in a plasticizer. The plastisol may further include, usually in minor amounts, extenders, stabilizers, pigments and/or fillers. The ratio between the PVC particles and the plasticizer may preferably be 50/50 by weight. In an embodiment the sublayer material consists of plastisol.

The sublayer material is configured to be at least partly plastically deformable when pressure is applied in order to at least form the bevel 10 of the building panel 1 and/or the groove 11. In order to make the sublayer material plastically deformable the material may either include a plasticizer or include at least two different types of polymers as described below.

If the sublayer material includes a plasticizer, it may be chosen from any of the groups of ortho-phthalates, terephthalates, aliphatics, cyclohexanoates, adipates, trimellitates, polyol esters and others, such as DOTP (dioctyl terephthalate), DEHP, DOA, DINP, DOP, ATBC, TOTM or Pevalen®. The sublayer material forming the sublayer comprise a plasticizer of an amount of 1-30 wt %, or 2-15 wt %. A plasticizer provides the sublayer with desirable formable properties.

As the alternative to the plasticizer the sublayer material may include at least two different types of polymers. For example the sublayer material may include a material blend comprising a PVC/PVAc co-polymer, where the PVAc content in the material blend of the sublayer is 1-20 wt % and the PVC content in the material blend may be 80-99 wt %.

The sublayer 5 created from the sublayer material preferably has a thickness of 0.1-2 mm, a thickness of 0.2-1 mm, or a thickness of 0.3-1 mm.

The sublayer may have a density of between 1.0 and 2.5 g/cm³. For example, if the sublayer comprises a plastisol the density of the sublayer may be as low as 1.0-1.4 g/cm³.

The sublayer may be foamed. The sublayer may be foamed and have a reduced density of at least 10%, at least 20% or at least 30% compared to a non-foamed sublayer of the same sublayer material. An advantage with a foamed sublayer is that it may reduce the weight of the layer. Further, a foamed sublayer material is not able to spring back after forming, e.g., a bevel, to the degree as a non-foamed sublayer material.

The surface layer 7 is arranged above and on the sublayer 5. An upper side of the surface layer 5 forms a front surface 8 of the building panel 1. The surface layer 7 may be a single layer surface layer or a multi-layer surface layer including two or more layers. Preferably, the surface layer 5 includes at least a decorative layer and a wear layer, where the decorative layer is arranged between the sublayer 5 and the wear layer and the wear layer is the uppermost layer of the building panel 1.

The decorative layer may be a coloured powder layer, a paper sheet, a polymer-based sheet, a wood-based sheet, a wood veneer, a cork-based sheet or a fabric, woven or non-woven. The decorative layer may also be a printed layer, e.g. a printed polymer-based sheet.

The wear layer may be a wear resistant foil, a wear layer having wear resistant particles and/or a lacquered layer. The wear layer is preferably a transparent layer, i.e., being a layer which does not affect the appearance of the below arranged decorative layer.

A coating (not shown) may be applied on the wear layer, thus forming the uppermost layer of the building panel 1 if applied.

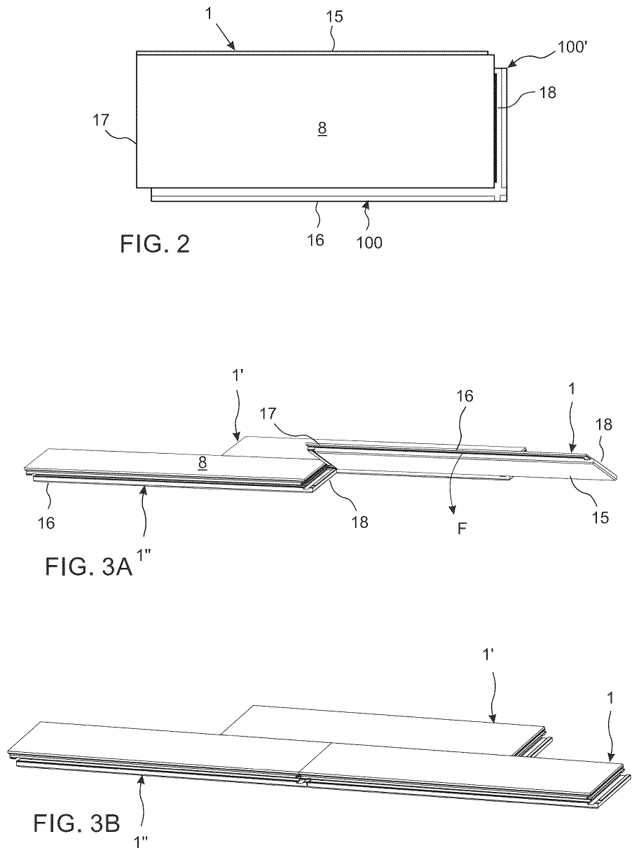

FIG. 2 is a top view of a building panel 1 configured to be horizontally and/or vertically locked to similar or essentially identical building panels 1′, 1″ in an assembling process.

The building panel in FIG. 2 is illustrated as having a rectangular shape but may in other embodiments have a different shape. However, the building panel 1 as illustrated in FIG. 2 includes four edges, the first edge 15, the second edge 16, the third edge 17 and the fourth edge 18. The first edge 15 is arranged opposite the second edge 16 and the third edge 17 is arranged opposite the fourth edge 18.

The front surface 8 and the back surface 4 each extends between the first edge 15 and the opposite second edge 16, and between the third edge 17 and the opposite fourth edge 18. The back surface 4 is substantially parallel to the front surface 8 and spaced apart in a direction perpendicular to the front surface 8.

The building panel 1, as described above, comprises a bevel 10, arranged in an upper portion 20 of the building panel 1, at least along the first and second edge 15, 16, i.e. the long sides of a building panel 1 having a rectangular shape. It may not always be desirable to have a bevel along the short sides of a rectangular building panel, but this is of course an optional arrangement to include a bevel along the short side as having a bevel 10 along the long sides of the building panel 1. The building panel 1 may be provided with a bevel 10 along both long sides and short sides, along only the long sides, along only the short sides, along only one long side, along only one short side, or along only one long side and one short side.

The upper portion 20 is located at the front side of the building panel 1 and may include both the surface layer 7 and at least partly the sublayer 5.

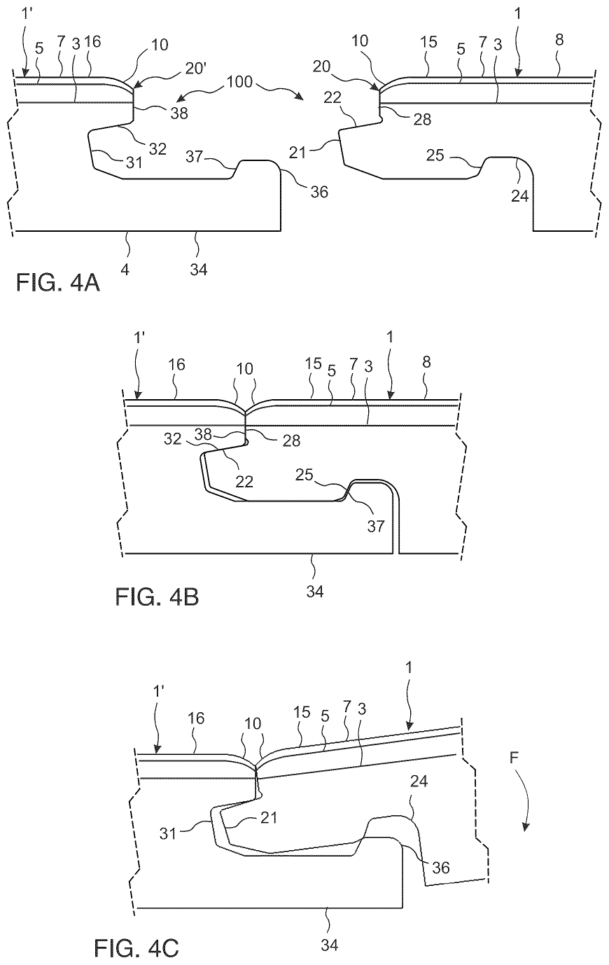

A bevel 10 may also be arranged along the third and fourth edges if desired. The bevel 10 may extend along the entire extension of the edges 15, 16 in which the bevel 10 is arranged. Schematic illustrations of the bevel 10 can be seen in FIGS. 4A-6C. The bevel 10 may extend into the surface layer 7 and at least partly into the sublayer 5 in a direction substantially perpendicular to the front surface 8.

Further, the building panel 1 may include at least one type of a mechanical locking device 100, 100′ configured to lock similar or essentially identical building panels 1, 1′, 1″ in an assembled position. Such a mechanical locking device 100, 100′ is configured to lock said building panels 1, 1′, 1″ in a vertical and/or horizontal direction, which also can be referred to as directions perpendicular and/or parallel to the back or front surface 4, 8.

In the illustrated embodiments the building panel 1 is provided with two types of mechanical locking devices, a first mechanical locking device 100, arranged along the first and second edges 15, 16, and a second mechanical locking device 100′, arranged along the third and fourth edges 17, 18. The first mechanical locking device 100 is designed such that a first edge 15 of a building panel 1 is configured to be assembled and locked to a second edge 16 of an adjacent building panel 1′, 1″ and the second edge 16 of the building panel 1 is configured to be assembled and locked to a first edge 15 of another adjacent building panel 1′, 1″ as the building panels are similar or essentially identical. The same applies to the second mechanical locking device 100′ where the third edge 17 of the building pane 1 is configured to be assembled and locked to the fourth edge 18 of an adjacent building panel 1′, 1″ and the fourth edge 18 of the building panel 1 is configured to be assembled and locked to the third edge 17 of another adjacent building panel 1′, 1″. Thus, the opposite edges of the building panel 1 are designed to be compatible with each other.

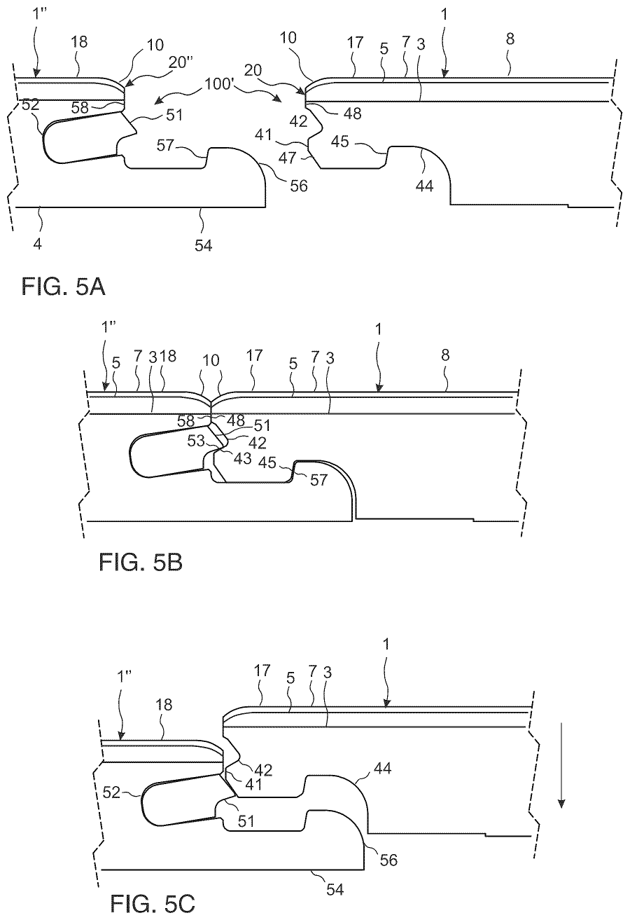

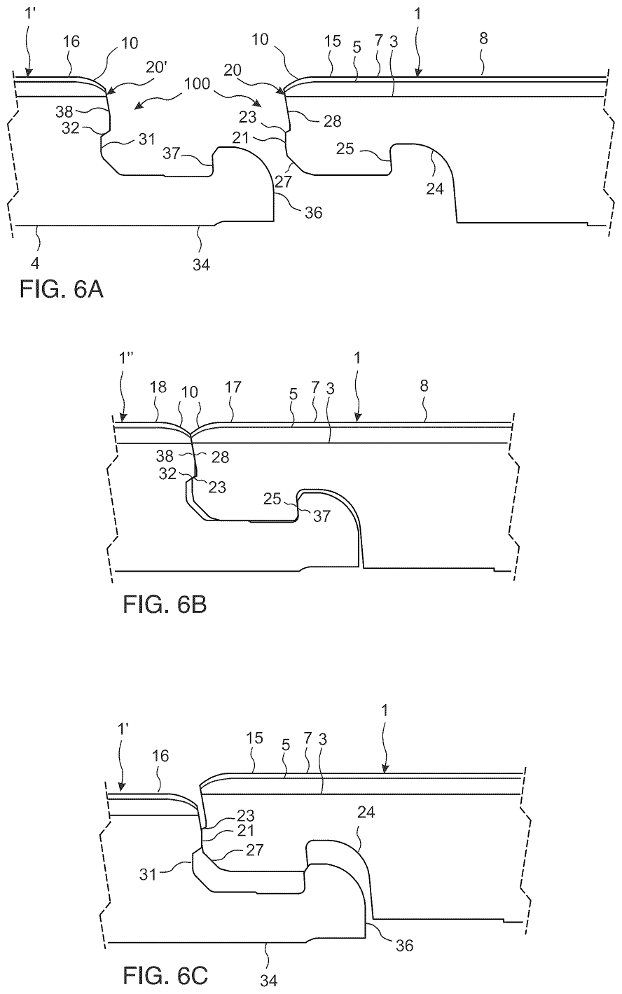

Embodiments of a first mechanical locking device 100 are illustrated in FIGS. 4A-4C and 6A-6C. An embodiment of a second mechanical locking device 100′ is illustrated in FIGS. 5A-5C.

The assembling process of multiple building panels 1, 1′, 1″ is illustrated in FIGS. 3A and 3B, where a set of building panels 1, 1′, 1″, such as floor panels, wall panels, ceiling panels, furniture elements or similar, are assembled to each other. A building panel 1 is assembled by firstly arranging its first edge 15 in the second edge 16 of an adjacent building panel 1′. The building panel 1 may preferably be displaced in a direction along the extension of the second edge 16 of the adjacent building panel 1′. After the building panel 1 is displaced into its desired position the first edge 15 of the building panel 1 is, by means of a folding displacement F, locked into the second edge 16 of the adjacent building panel 1′ simultaneously as the third edge 17 of the building panel is assembled and locked to a fourth edge 18 of another adjacent building panel 1″. The building panel 1 is folded down such that the second edge 16 of the building panel 1 is displaced in a direction perpendicular to the front surface 8 in relation to the first edge 15. The mechanical locking device 100′ arranged along the third edge 17 and fourth edge 18 is configured to assemble and lock the adjacent third edge 17 and fourth edge 18 continuously throughout the folding displacement F of the building panel 1.

FIGS. 4A, 4B and 4C illustrate a cross section of two opposite edges 15, 16 of two adjacent building panels 1, 1′ provided with the first mechanical locking device 100 in an unassembled position, in an assembled position and in a position during the assembly. The two adjacent building panels 1, 1′ are assembled by means of the folding displacement as explained above and locked together by means of the mechanical locking device 100. This type of mechanical locking device may be especially advantageous to use along the long sides of a rectangular building panel.

The mechanical locking device 100, at the first edge 15 of the building panel 1, is provided with a locking tongue 21 extending out from the first edge 15. The locking tongue 21 is configured to be received in a tongue groove 31 provided in the second edge 16 of the adjacent building panel 1′. The locking tongue 21 and the tongue groove 31 are configured to lock the two adjacent building panels 1, 1′ at least in a direction perpendicular to the front surface 8. In the assembled position an upper surface 22 of the locking tongue 21 is cooperating or even in contact with an upper surface 32 of the tongue groove 31, where the two surfaces 22, 32 creates the lock in at least a direction perpendicular to the front surface 8.

Below the upper surface 32 of the tongue groove 31, seen from the front surface 8, there is provided a locking strip 34 extending out from the second edge 16 of the adjacent building panel 1′. At an outermost end of the locking strip 34 there is provided a locking element 36. The locking element 36 is configured to be received in a locking groove 24 provided at the first edge 15 of the building panel 1. The locking element 36 and the locking groove 24 are configured to lock the two adjacent building panels 1, 1′ at least in a direction parallel to the front surface 8. In the assembled position a locking surface 25 of the locking groove 24 is cooperating or even in contact with a locking surface 37 of the locking element 36, where the two locking surfaces 25, 37 creates the lock in at least a direction parallel to the front surface 8.

In the upper portion 20, 20′ of each building panel 1, 1′ there is provided another two locking surfaces 28, 38. The locking surfaces 28, 38 are, in the assembled position, arranged opposite each other, cooperating or even in contact with each other in order to lock the two adjacent building panels 1, 1′ in a direction parallel to the front surface 8. Preferably the two locking surfaces 28, 38 create a tight seal in the assembled position. A tight seal has several advantages, such as mitigating the risk of dirt or fluids entering down into the mechanical locking device 100 which could damage the building panels 1, 1′, or such as creating a desirable transition between two adjacent building panels 1, 1′ in which also the bevel 10 may be favourable. Creating a desirable transition between the adjacent building panels 1, 1′ may be especially desirable if a decorative layer of the surface layer 7 is a printed layer of any material since the printed layer then can transition into the adjacent printed layer without a gap, which could interrupt the decorative surface. An interruption in the decorative surface could create an undesirable surface décor when multiple building panels 1, 1′, 1″ are assembled to create a panel board, e.g. a floor, wall or the like.

The two locking surfaces 28, 38 extend in a direction substantially perpendicular to the front surface 8. The two locking surfaces 28, 38 are the uppermost pair of locking surfaces of the two adjacent building panels 1, 1′ in the assembled position.

FIGS. 5A, 5B and 5C illustrate a cross section of two opposite edges 17, 18 of two adjacent building panels 1, 1″ provided with the second mechanical locking device 100′ in an unassembled position, in an assembled position and in a position during the assembly. The two adjacent building panels 1, 1″ are assembled by means of the folding displacement and the continuous vertical displacement of the second edge 16 in relation to the first edge 15 as explained above, and locked together by means of the mechanical locking device 100′. This type of mechanical locking device may especially be advantageous to use along the short sides of a rectangular building panel or for square tiles.

The mechanical locking device 100′, at the third edge 17 of the building panel 1, is provided with a locking tongue 41 provided with a tongue groove 42. The tongue groove 42 is configured to receive a displaceable locking tongue 51 arranged in a displaceable tongue groove 52 in the fourth edge 18 of the adjacent building panel 1″, in the assembled position. The displaceable locking tongue 51 and the tongue groove 42 are configured to lock the two adjacent building panels 1, 1″ at least in a direction perpendicular to the front surface 8.

The displaceable locking tongue 51 may be separate from the rest of the mechanical locking device 100′ and arranged within the displaceable tongue groove 52 e.g. by hand or a machine when before or during the assembly of building panels 1, 1′, 1″. The displaceable locking tongue 51 is configured to be displaced, by being at least partly flexible, within the displaceable tongue groove 52 as the locking tongue 41 at the third edge of the building panel 1 is displaced down, in a direction perpendicular to the front surface 8, towards the assembled position, see FIG. 5C. When the displaceable locking tongue 51 reaches the tongue groove 42 it snaps into a locked position, see FIG. 5B, and locks the two adjacent building panels 1, 1″ at least in a direction perpendicular to the front surface 8. In the assembled position a lower locking surface 43 of the tongue groove 42 is cooperating or even in contact with a lower locking surface 53 of the displaceable locking tongue 51, where the two locking surfaces 43, 53 creates a lock of the assembled panels 1, 1″ in at least the direction perpendicular to the front surface 8.

Below the displaceable tongue groove 52, seen from the front surface 8, there is provided a locking strip 54 extending out from the fourth edge 18 of the adjacent building panel 1″. At an outermost end of the locking strip 54 there is provided a locking element 56. The locking element 56 is configured to be received in a locking groove 44 provided at the third edge 17 of the building panel 1. The locking element 56 and the locking groove 44 are configured to lock the two adjacent building panels 1, 1″ at least in a direction parallel to the front surface 8. In the assembled position a locking surface 45 of the locking groove 44 is cooperating or even in contact with a locking surface 57 of the locking element 56, where the two locking surfaces 45, 57 creates the lock in at least the direction parallel to the front surface 8.

In the upper portion 20, 20″ of each building panel 1, 1″ there are provided another two locking surfaces 48, 58. The locking surfaces 48, 58 are, in the assembled position, arranged opposite each other, cooperating or even in contact with each other in order to lock the two adjacent building panels 1, 1″ in a direction parallel to the front surface 8. Preferably the two locking surfaces 48, 58 creates a tight seal in the assembled position. A tight seal has several advantages, such as mitigating the risk of dirt or fluids entering down into the mechanical locking device 100′ which could damage the building panels 1, 1′, or such as creating a desirable transition between two adjacent building panels 1, 1″ in which also the optional bevel 10 may be favourable. Creating a desirable transition between the adjacent building panels 1, 1″ may be especially desirable if a decorative layer of the surface layer 7 is a printed layer of any material since the printed layer then can transition into the adjacent printed layer without a gap, which could interrupt the decorative surface. An interruption in the decorative surface could create an undesirable surface décor when multiple building panels 1, 1′, 1″ are assembled to create a panel board, e.g. a floor, wall or the like.

The two locking surfaces 48, 58 extend in a direction substantially perpendicular to the front surface 8. The two locking surfaces 48, 58 are the uppermost pair of locking surfaces of the two adjacent building panels 1, 1″ in the assembled position.

FIGS. 6A, 6B and 6C illustrate a cross section of two opposite edges 15, 16 of two adjacent building panels 1, 1′ provided with an alternative first mechanical locking device 100 in an unassembled position, in an assembled position and in a position during the assembly. With this alternative mechanical locking device 100 the two adjacent building panels 1, 1′ are assembled by means of a vertical displacement, instead of a folding displacement, of the building panel 1 in relation to the adjacent building panel 1′. The mechanical locking device 100, at the first edge 15 of the building panel 1, is provided with a locking tongue 21 having a ridge 23. The ridge 23 is configured to receive an upper surface 32 of a tongue groove 31 provided in the second edge 16 of the adjacent building panel 1′. The ridge 23 and the upper surface 32 of the tongue groove 31 are configured to lock the two adjacent building panels 1, 1′ at least in a direction perpendicular to the front surface 8. When the ridge 23 reaches the upper surface 32 of the tongue groove 31 it snaps into a locked position, see FIG. 6B, and locks the two adjacent building panels 1, 1′ at least in a direction perpendicular to the front surface 8.

In the assembled position the ridge 23 of the locking tongue 21 is cooperating or even in contact with the upper surface 32 of the tongue groove 31, creating the lock in at least a direction perpendicular to the front surface 8.

Below the upper surface 32 of the tongue groove 31, seen from the front surface 8, there is provided a locking strip 34 extending out from the second edge 16 of the adjacent building panel 1′. At an outermost end of the locking strip 34 there is provided a locking element 36. The locking element 36 is configured to be received in a locking groove 24 provided at the first edge 15 of the building panel 1. The locking element 36 and the locking groove 24 are configured to lock the two adjacent building panels 1, 1′ at least in a direction parallel to the front surface 8. In the assembled position a locking surface 25 of the locking groove 24 is cooperating or even in contact with a locking surface 37 of the locking element 36, where the two locking surfaces 25, 37 creates the lock in at least a direction parallel to the front surface 8.

In the upper portion 20, 20′ of each building panel 1, 1′ there is provided another two locking surfaces 28, 38. The locking surfaces 28, 38 are, in the assembled position, arranged opposite each other, cooperating or even in contact with each other in order to lock the two adjacent building panels 1, 1′ in a direction parallel to the front surface 8. Preferably the two locking surfaces 28, 38 create a tight seal in the assembled position. A tight seal has several advantages, such as mitigating the risk of dirt or fluids entering down into the mechanical locking device 100 which could damage the building panels 1, 1′, or such as creating a desirable transition between two adjacent building panels 1, 1′ in which also the bevel 10 may be favourable. Creating a desirable transition between the adjacent building panels 1, 1′ may be especially desirable if a decorative layer of the surface layer 7 is a printed layer of any material since the printed layer then can transition into the adjacent printed layer without a gap, which could interrupt the decorative surface. An interruption in the decorative surface could create an undesirable surface decor when multiple building panels 1, 1′, 1″ are assembled to create a panel board, e.g. a floor, wall or the like.

The two locking surfaces 28, 38 extend in a direction substantially perpendicular to the front surface 8. The two locking surfaces 28, 38 are the uppermost pair of locking surfaces of the two adjacent building panels 1, 1′ in the assembled position.

An advantage with having a pressed bevel 10 as described herein in combination with a mechanical locking device 100 as illustrated in FIGS. 5A-5C and 6A-6C, where the building panels 1, 1′, 1″ are assembled by a substantially vertical displacement, is that the bevel 10 may act as a guiding surface for an angled surface 27, 47 of the locking tongue 21, 41. This may occur when the building panel 1 to be assembled is arranged slightly overlapping the adjacent building panel 1′, 1″. The pressed bevel 10 with its seamless surface may then provide a smooth sideways movement of the building panel 1 such that the building panel 1 to be assembled is displaced in the correct position.

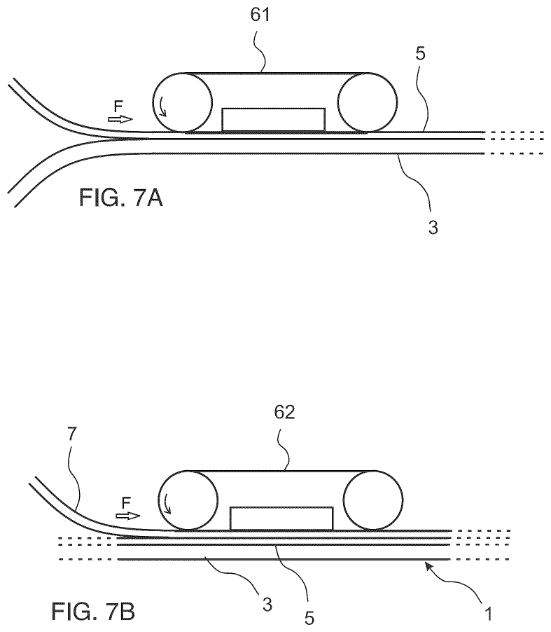

FIGS. 7A and 7B schematically illustrate a possible method to manufacture a building panel 1 or a panel board 2 from which multiple building panels 1 may be extracted from by e.g. a cutting process.

A first step is to join a substrate material and a sublayer material to form a substrate 3 and a sublayer 5 of the building panel 1 or panel board 2. The substrate material and the sublayer material may be joined together by means of heat and pressure with a first single pressing device 61 as can be seen in FIG. 7A. The first single pressing device 61 is preferably a continuous pressing device 61 through which the substrate material and the sublayer material are fed in a feeding direction F at a constant speed. A typical speed through a continuous pressing device 61 is between 10 m/min and 40 m/min, preferably around 30 m/min.

The substrate material is in the illustrated example a single layer material, creating a single layer substrate 3 of the building panel 1 or panel board 2. The substrate material includes a polymer-based material which preferably is a thermoplastic material. The thermoplastic material may be chosen from a group comprising: polyvinyl chloride (PVC), polyethylene terephthalate (PET), polyvinyl butyral (PVB), polybutylene terephthalate (PBT), polyethylene (PE), polystyrene (PS), polypropylene (PP), polycarbonate (PC), polyvinyl acetate (PVAc), ethylene-vinyl acetate (EVA), polyacrylate methacrylate, polymethylmethacrylate (PMMA), acrylonitrile butadiene styrene (ABS), thermoplastic polyurethane (TPU), and/or a combination thereof.

The substrate material may comprise an amount of at least 10 wt %, at least 15 wt % or at least 20 wt % of the polymer-based material, such as the thermoplastic material.

The substrate material preferably may comprise less than 10 wt % wood-based material, or less than 5 wt % wood-based material.

The substrate material may further include at least one or more of an organic filler, an inorganic filler, or a combination thereof. Examples of organic fillers are fibres of bamboo or coconut and rice husks. These types of organic fillers are often cost efficient and easy to get hold of. The substrate may comprise 1-70 wt % organic filler, or 30-70 wt % organic filler. Examples of inorganic fillers are calcium carbonate (CaCO3), barium sulphate (BaSO4), talc, and/or a combination thereof. These types of fillers are especially cost efficient and easy to get a hold of.

The substrate may further include a plasticizer. The plasticizer may be chosen from any of the groups of ortho-phthalates, terephthalates, aliphatics, cyclohexanoates, adipates, trimellitates, polyol esters and others, such as DOTP (dioctyl terephthalate), DEHP, DOA, DINP, DOP, ATBC, TOTM or Pevalen®. The substrate material forming the substrate may comprise a plasticizer of an amount of 1-30 wt %, or 2-15 wt %.

A typical SPC substrate which may be preferred to use for this type of application, may include 10-40 wt %, 15-35 wt %, or 20-30 wt % of a thermoplastic material, such as PVC. The SPC core may further include 50-90 wt %, 60-80 wt % or 65-75 wt % of an inorganic filler, such as chalk. The SPC core may further include 0-20 wt %, 1-15 wt % or 2-10 wt % of additives, such as impact modifier, stabilizer, lubricant and/or pigment.

A typical LVT substrate, which also may be preferred to use for this type of application, would have a similar content of material as the SPC substrate above, i.e. 10-40 wt %, 15-35 wt %, or 20-30 wt % of a thermoplastic material, 50-90 wt %, 60-80 wt % or 65-75 wt % of an inorganic filler and 0-20 wt %, 1-15 wt % or 2-10 wt % of additives, but with the addition of 1-20 wt %, 2-15 wt % or 3-10 wt % of a plasticizer.

The sublayer material creates the sublayer 5 of the building panel 1 or panel board 2 and includes a polymer-based material, preferably a thermoplastic material. The thermoplastic material of the sublayer material may be chosen from a group comprising: polyvinyl chloride (PVC), polyethylene terephthalate (PET), polyvinyl butyral (PVB), polybutylene terephthalate (PBT), polyethylene (PE), polystyrene (PS), polypropylene (PP), polycarbonate (PC), polyvinyl acetate (PVAc), ethylene-vinyl acetate (EVA), polyacrylate methacrylate, polymethylmethacrylate (PMMA), acrylonitrile butadiene styrene (ABS), thermoplastic polyurethane (TPU), and/or a combination thereof.

The sublayer material may include an amount of at least 10 wt %, at least 15 wt % or at least 20 wt % of the polymer-based material, such as the thermoplastic material.

The sublayer material is, as described above, a polymer-based material. The sublayer material may include less than 10 wt % wood-based material, or even less than 5 wt % wood-based material.

The sublayer material may further comprise one or more fillers which is at least one or more of an organic filler, an inorganic filler, or a combination thereof. Fillers have the advantage of, e.g., improving layer properties and being cost efficient. Examples of organic fillers are fibres of bamboo or coconut, wood flour and rice husks. These types of organic fillers are often cost efficient and easy to get hold of. The sublayer may comprise 1-70 wt % organic filler, or 30-70 wt % organic filler. Examples of inorganic fillers are calcium carbonate (CaCO3), barium sulphate (BaSO4), talc, and/or a combination thereof. These types of fillers are especially cost efficient and easy to get a hold of.

Where the sublayer material is a mineral-based filler, and especially if it is calcium carbonate (CaCO₃), it includes an amount of 1-80 wt % of such filler.

Further, the sublayer material may include plastisol. Plastisol gives the sublayer soft and durable properties. A plastisol is a composition of PVC particles suspended in a plasticizer. The plastisol may further include, usually in minor amounts, extenders, stabilizers, pigments and/or fillers. The ratio between the PVC particles and the plasticizer may preferably be 50/50 by weight. In an embodiment the sublayer material consists of plastisol.

The sublayer material is configured to be at least partly plastically deformable when pressure is applied in order to at least form a bevel 10 of the building panel 1 or a groove 11 of a panel board 2. In order to make the sublayer material plastically deformable the material may either include a plasticizer or include at least two different types of polymers as described below.

If the sublayer material includes a plasticizer, it may be chosen from any of the groups of ortho-phthalates, terephthalates, aliphatics, cyclohexanoates, adipates, trimellitates, polyol esters and others, such as DOTP (dioctyl terephthalate), DEHP, DOA, DINP, DOP, ATBC, TOTM or Pevalen®. The sublayer material forming the sublayer comprise a plasticizer of an amount of 1-30 wt %, or 2-15 wt %. A plasticizer provides the sublayer with desirable formable properties.

As the alternative to the plasticizer the sublayer material includes at least two different types of polymers. For example the sublayer material may include a material blend comprising a PVC/PVAc co-polymer, where the PVAc content in the material blend of the sublayer is 1-20 wt % and the PVC content in the material blend may be 80-99 wt %.

The sublayer 5 created from the sublayer material preferably has a thickness of 0.1-2 mm, a thickness of 0.2-1 mm, or a thickness of 0.3-1 mm.

The sublayer may have a density of between 1.0 and 2.5 g/cm³. For example, if the sublayer comprises a plastisol the density of the sublayer may be as low as 1.0-1.4 g/cm³.

The sublayer may be foamed. The sublayer may be foamed and have a reduced density of at least 10%, at least 20% or at least 30% compared to a non-foamed sublayer of the same sublayer material. An advantage with a foamed sublayer is that it may reduce the weight of the layer. Further, a foamed sublayer material is not able to spring back after forming, e.g., a bevel, to the degree as a non-foamed sublayer material.

A second step is to apply a surface layer 7 to the sublayer 5 and again apply at least pressure but preferably also heat in order to form the building panel 1 or panel board 2. The pressure applied may be between 5 bar and 20 bar and the temperature applied may be between 120° C. and 160° C. The pressure and preferably also heat is achieved by means of a second single pressing device 62, as can be seen in FIG. 7B. The second single pressing device 62 is preferably a continuous pressing device 62 through which the substrate, the sublayer and the surface layer are fed in a feeding direction F at a constant speed. The speed in which the layers are fed through the second pressing device 62 may be the same speed as the materials are fed through the first single pressing device 61, i.e., between 10 m/min and 40 m/min, preferably around 30 m/min.

The surface layer 7 includes a decorative layer 11. The decorative layer may be a coloured powder layer, a paper sheet, a polymer-based sheet, a wood-based sheet, a wood veneer, a cork-based sheet or a fabric, woven or non-woven. The decorative layer may further be a printed polymer-based sheet.

Further, the surface layer 7 includes a wear layer, such as a wear resistant foil, a wear layer having wear resistant particles and/or a lacquered layer and/or a coating layer.

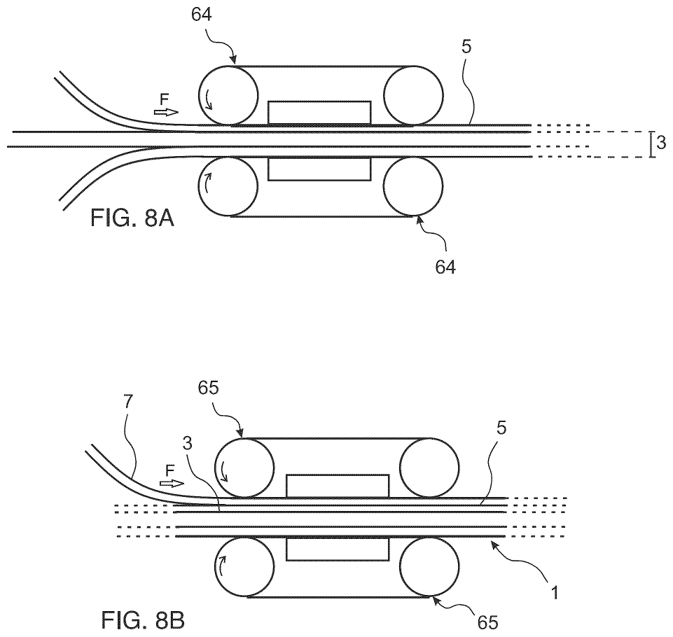

FIGS. 8A and 8B schematically illustrate another possible method of manufacturing a building panel 1 or a panel board 2 from which multiple building panels 1 may be extracted from by e.g. a cutting process.

Similar to the method described in FIGS. 7A and 7B, a first step is to join a substrate material and a sublayer material to form a substrate 3 and a sublayer 5 of the building panel 1 or panel board 2. The substrate material and the sublayer material may be joined together by means of heat and pressure with a first double pressing device 64 as can be seen in FIG. 8A. The first double pressing device 64 is preferably a continuous pressing device 64 through which the substrate material and the sublayer material is fed in a feeding direction F at a constant speed. As previously described, a typical speed is between 10 m/min and 40 m/min, preferably around 30 m/min. The pressure applied may be between 5 bar and 20 bar and the temperature applied may be between 120° C. and 160° C.

The substrate material is in this illustrated example a multi-layered material, creating a multi-layered substrate 3 of the building panel 1 or panel board 2. The multi-layered substrate material may include one or more of e.g. a backing layer, a balancing layer, a reinforcement layer, a mineral-based layer, or a sound dampening layer.

The substrate material includes a polymer-based material which preferably is a thermoplastic material. The thermoplastic material may be chosen from a group comprising: polyvinyl chloride (PVC), polyethylene terephthalate (PET), polyvinyl butyral (PVB), polybutylene terephthalate (PBT), polyethylene (PE), polystyrene (PS), polypropylene (PP), polycarbonate (PC), polyvinyl acetate (PVAc), ethylene-vinyl acetate (EVA), polyacrylate methacrylate, polymethylmethacrylate (PMMA), acrylonitrile butadiene styrene (ABS), thermoplastic polyurethane (TPU), and/or a combination thereof.

The substrate material may comprise an amount of at least 10 wt %, at least 15 wt % or at least 20 wt % of the polymer-based material, such as the thermoplastic material.

The substrate material preferably may have less than 10 wt % wood-based material, or less than 5 wt % wood-based material.

The substrate material further includes at least one or more of an organic filler, an inorganic filler, or a combination thereof. Examples of organic fillers are fibres of coconut or bamboo and rice husks. These types of organic fillers are often cost efficient and easy to get hold of. The substrate may comprise 1-70 wt % organic filler, or 30-70 wt % organic filler. Examples of inorganic fillers are calcium carbonate (CaCO3), barium sulphate (BaSO4), talc, and/or a combination thereof. These types of fillers are especially cost efficient and easy to get a hold of.

The substrate may further include a plasticizer, chosen from any of the groups of ortho-phthalates, terephthalates, aliphatics, cyclohexanoates, adipates, trimellitates, polyol esters and others, such as DOTP (dioctyl terephthalate), DEHP, DOA, DINP, DOP, ATBC, TOTM or Pevalen®. The substrate material forming the substrate may comprise a plasticizer of an amount of 1-30 wt %, or 2-15 wt %.

A typical SPC substrate which may be preferred to use for this type of application, may include 10-40 wt %, 15-35 wt %, or 20-30 wt % of a thermoplastic material, such as PVC. The SPC core may further include 50-90 wt %, 60-80 wt % or 65-75 wt % of an inorganic filler, such as chalk. The SPC core may further include 0-20 wt %, 1-15 wt % or 2-10 wt % of additives, such as impact modifier, stabilizer, lubricant and/or pigment.

A typical LVT substrate, which also may be preferred to use for this type of application, would have a similar content of material as the SPC substrate above, i.e. 10-40 wt %, 15-35 wt %, or 20-30 wt % of a thermoplastic material, 50-90 wt %, 60-80 wt % or 65-75 wt % of an inorganic filler and 0-20 wt %, 1-15 wt % or 2-10 wt % of additives, but with the addition of 1-20 wt %, 2-15 wt % or 3-10 wt % of a plasticizer.

The sublayer material which creates the sublayer 5 of the building panel 1 or panel board 2 may be the same in respect of possible content and amounts as previously defined for FIGS. 7A and 7B. Also the preferred thickness of the sublayer 5 may be the same as described above.

A second step is, like the method previously described, to apply a surface layer 7 to the sublayer 5 and again apply at least pressure but preferably also heat in order to form the building panel 1 or panel board 2. The pressure and preferably also heat is achieved by means of a second double pressing device 65, as can be seen in FIG. 8B. The second double pressing device 65 is preferably a continuous double pressing device 65 through which the substrate 3, the sublayer 5 and the surface layer 7 are fed in a feeding direction F at a constant speed. The speed in which the layers are fed through the second pressing device 65 may be the same speed as the materials are fed through the first pressing device 64. As previously described, a typical speed is between 10 m/min and 40 m/min, preferably around 30 m/min.

The surface layer 7 includes, as previously described, a decorative layer 11. The decorative layer may be a coloured powder layer, a paper sheet, a polymer-based sheet, a wood-based sheet, a wood veneer, a cork-based sheet or a fabric, woven or non-woven. The decorative layer may further be a printed polymer-based sheet.

Further, the surface layer 7 may include, as previously described, a wear layer, such as a wear resistant foil, a wear layer having wear resistant particles and/or a lacquered layer and/or a coating layer.

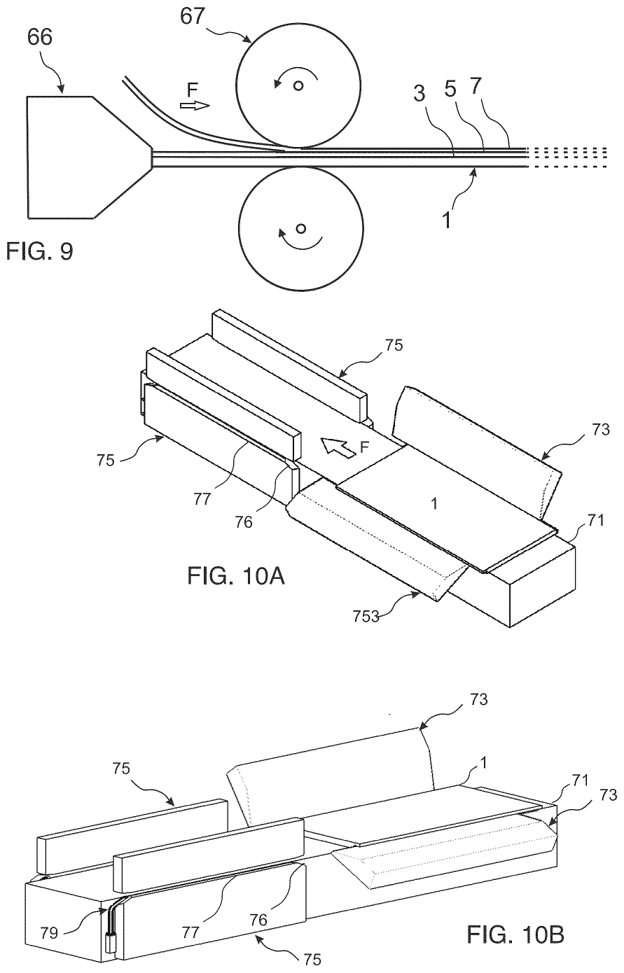

FIG. 9 illustrates an alternative method where the different materials, i.e. substrate material and sublayer material, are created in an extruding process 66 and fed through a calendering process 67 for forming the building panel 1 or panel board 2. The surface layer 7 may be applied before the calendering process 67, for forming the building panel 1 or panels board 2. An extruding process 66 is able to extrude one or more materials into single-layer panels or multi-layer panels.

FIGS. 10A and 10B illustrate different views of one possible set up for a process of forming a bevel 10 along two opposite edges 15, 16 of a building panel 1, in the illustrated example the long sides are formed with bevels 10. The building panel 1 is transported on a conveyor belt 71 in a feeding direction F. The building panel 1, which previously has been formed into its desired proportions, may be transported through a heating process 73. The heating process 73 is configured to heat an area along each edge of the building panel 1 if, necessary, to be able to form the bevel 10 in a later stage.

In an alternative set up for a process of forming the bevel (not shown), the heating process may be excluded, and the building panel is transported directly from the heat and pressure process when forming the building panel to the bevel forming process. In that set up the heat used when forming the building panel is used for forming the bevel, i.e. the area along the edges of the building panel, is still sufficiently hot for conducting the bevel forming process.

In another alternative set up for a process of forming the bevel (not shown), the heating process may be included in the bevel forming process, i.e. the two processes are not separate processes but incorporated with the bevel forming process in a combined heating and bevel forming process.

Thus, there are a multiple possible set ups for the manufacturing process, e.g. the bevel 10 may be created simultaneously as the building panel is formed by means of heat and pressure (described below), or the bevel 10 may be formed in a process subsequent of the process forming the building panel 1 but where the heat used in the process of forming the building panel 1 is sufficient for the subsequent bevel forming process, or the bevel 10 may be formed in a process subsequent of the process forming the building panel 1 where the bevel forming process includes heating at least the area of the building panel 1 in which the bevel is to be created, or even having a bevel forming process without heat, just using pressure to form the bevel 10.

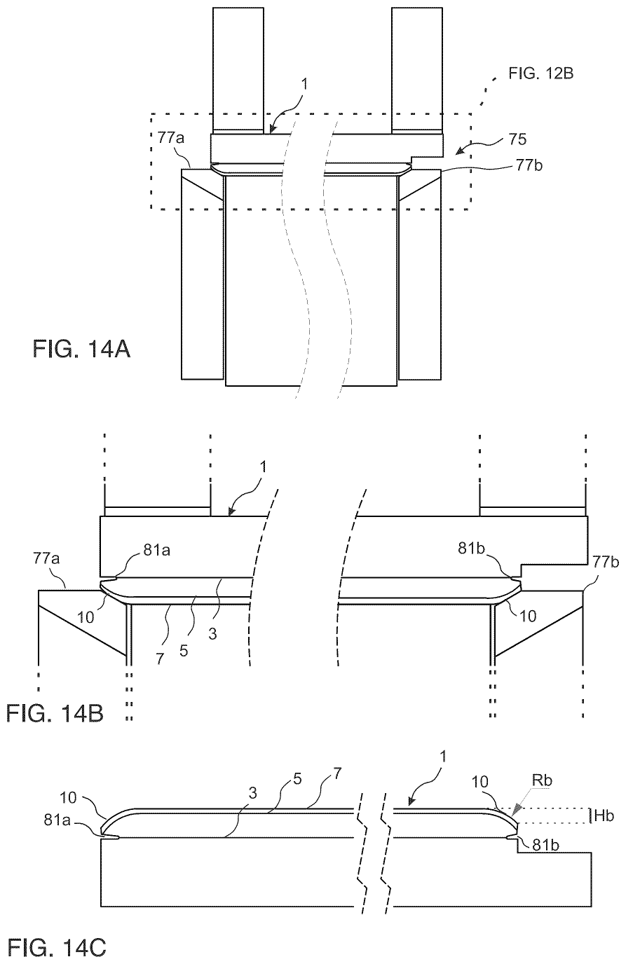

After the heating process 73, as illustrated in FIGS. 10A and 10B, the building panel 1 is transported to a bevel forming process 75. The edges of the building panel 1 are guided into the bevel forming process 75 by a guiding surface 76. The bevel forming process 75 is configured to form the bevel 10 either from above, i.e. the surface facing upwards, or from underneath, i.e. the surface facing downwards towards the conveyor belt 71, by pressing on or shaping the surface layer 7 by means of a shaping device 77. A more detailed view of one type of bevel forming process 75 is illustrated in FIGS. 14A-C and described below.

An alternative method (not shown) to the above described bevel forming process is to press the bevel 10 of the building panel 1 simultaneously as forming the building panel itself and joining the layers, i.e. the substrate, sublayer, and surface layer, together. The at least one bevel 10 may be created with the same pressing device as forms the building panel. The pressing device may then preferably be provided with features, e.g. protrusions, for creating such bevel.

After and in the vicinity of the bevel forming process 75 there is arranged a cooling process 79 for cooling the bevel 10 and the area in the edges in which the bevel 10 has been formed. The cooling process 79 is advantageous in order to prevent an undesirable elasticity and/or recovery effect in the material of the bevel 10. The cooling process 79 is advantageous in order to maintain the shape and proportions of the bevel 10.

The cooling process 79 is preferably an active process in order to shorten the time compared to letting the temperature in the material decrease by means of the surrounding environment. The cooling process 79 may be achieved by a cooling device 87a, 87b using air, liquid, gas, solid materials and/or other suitable means. The cooling device 87a, 87b may perform the cooling through, e.g., blowing, spraying, evaporation and/or through contact. The cooling process 79 may be configured to decrease the temperature, in the area of the material where the bevel is formed, between 15% and 40%. Depending on the type of cooling the cooling device uses and the temperature of such cooling the time spent by the cooling process may vary. For example, if cold water is used the cooling process may take between 2 sec. and 20 sec., and if cold air is used the cooling process may take between 30 sec. and 2 min, all depending on the type of cooling and the temperature.

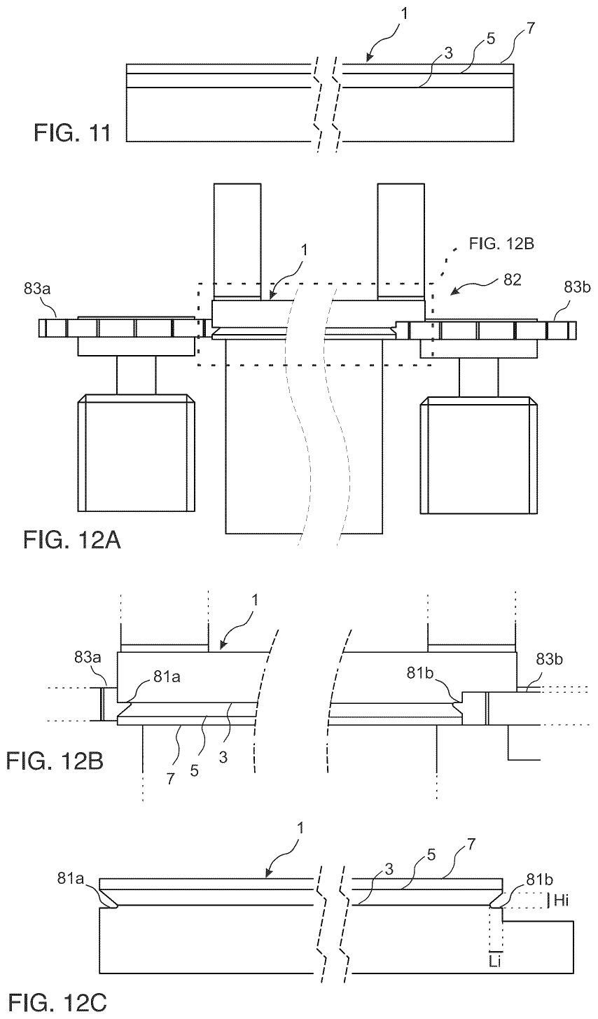

FIGS. 11-18 illustrate different steps of a possible set up for processing the edges 15, 16, 17, 18 of a building panel 1, where FIG. 11 illustrates a building panel 1 with the substrate 3, the sublayer 5 and the surface layer 7 after being joined together by pressure and preferably also heat.

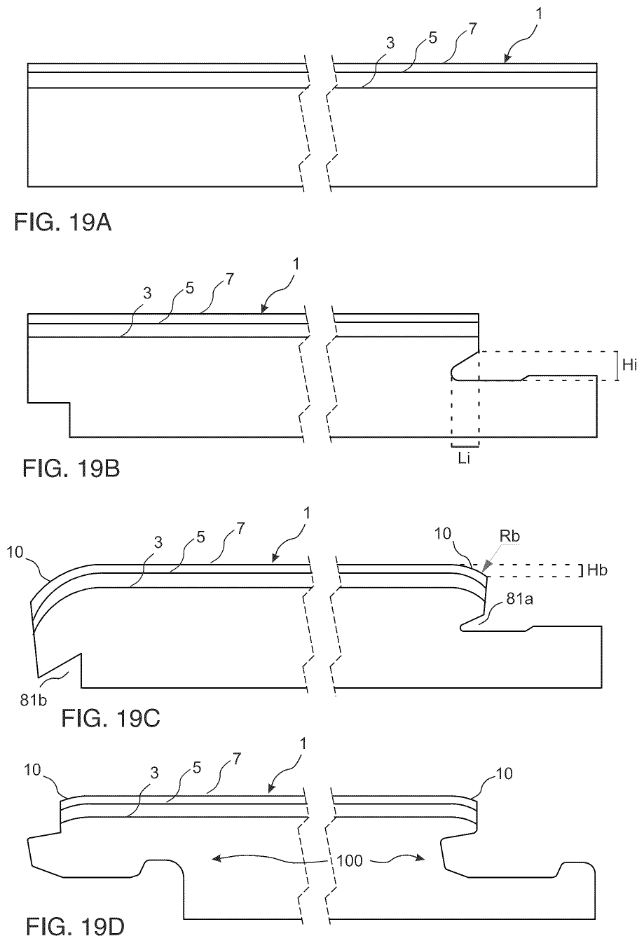

The set up for a final processing of the edges 15, 16, 17, 18 of a building panel 1 illustrated in FIGS. 11-18 is particularly advantageous when the building panel 1 includes a substrate 3 which is not, or at least not sufficiently, plastically deformable. However, FIGS. 19A-19D illustrate a possible set up for a final processing of the edges 15, 16, 17, 18 of a building panel 1 having a substrate 3 which is sufficiently plastically deformable.

It is possible to form a bevel 10 along the building panel 1 directly after the building panel 1 has been formed by means of pressure and preferably also heat but in order to mitigate the forming of the bevel 10 even further a process of creating an indentation 81a, 81b may be performed.

A possible way of creating an indentation 81a, 81b is illustrated in FIGS. 12A-12C. The indentations 81a, 81b are preferably temporary features of the edge 15, 16, 17, 18 of the building panel 1 which during a final shaping process i.e. a calibrating process, in no longer present in its original shape. Examples of calibrating processes are described below.

In this indentation creating process the building panel 1 is placed in or transported to, preferably by means of a conveyor belt, a milling process 82. The building panel 1 is often processed with its substrate 3 facing upwards and its surface layer 7 facing downwards, but it may of course be processed the other way around in an alternative embodiment, with its substrate 3 facing downwards and its surface layer 7 facing upwards.

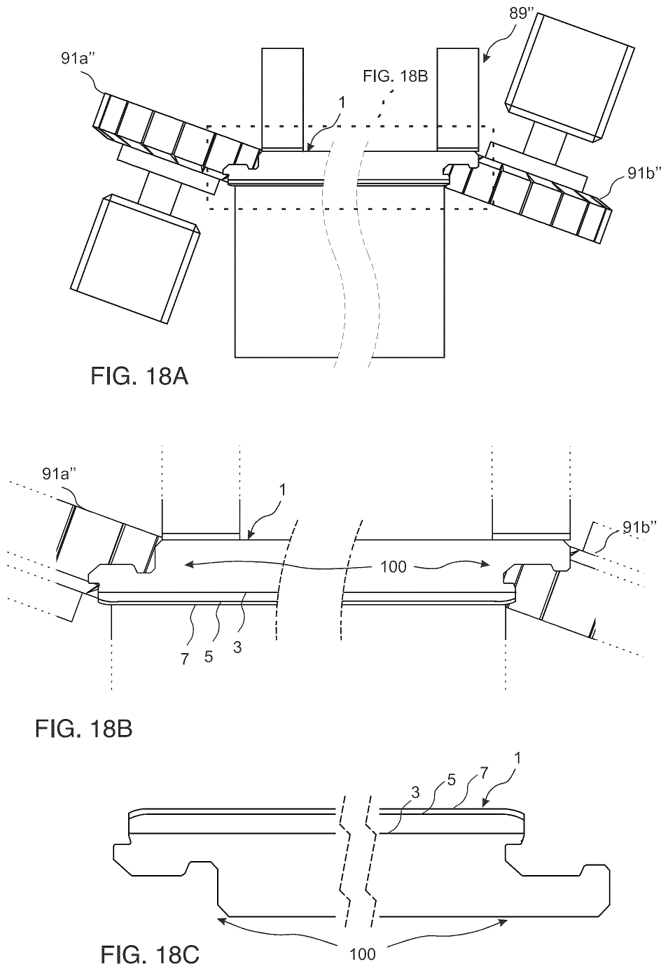

A milling device 83a, 83b is arranged on each side of the building panel 1. The milling devices 83a, 83b are configured to each create an indentation 81a, 81b along the edges 15, 16 of the building panel 1 in which the bevels 10 are to be formed. The milling devices 83a, 83b may also configured to create an indentation 81, 81b suitable for the type of mechanical locking device 100, 100′ later created in the edges 15, 16. A purpose to do so is that the indentation 81a, 81b then will not affect or interfere with the proportions, shapes, and functions of the later created mechanical locking device 100, 100′, see FIGS. 18A-18C.

Advantages of creating the indentations 81a, 81b before forming the bevel 10 are that space is created for material to be displace during the pressing and forming of the bevel, decreasing the risk of unwanted excess material gathering which later has to be removed, and decreasing the tendency of the material to elastically go back and/or recover and changing the properties and shape of the bevel 10.

In the illustrated example, each milling device 83a, 83b is configured to create the indentations 81a, 81b mainly in the sublayer 5 in the area close to the substrate 3, but may in other embodiments be created at least partly in the substrate 3 and/or the surface layer 7 as well. The indentations 81a, 81b are preferably created in the boundary between the sublayer 5 and the substrate 3. One of the milling devices 83b is further configured to remove material from the substrate 3 in order to prepare for the intended mechanical locking device 100 as illustrated in FIGS. 18A-18C.

The indentation 81a, 81b may preferably extend, in a direction parallel to the plane defining the front surface 8 of the building panel 1 and into the building panel 1, the same length as or further than the extension of the intended bevel 10 to be formed.

Where a mechanical locking device 20 is to be formed in the building panel 1, the indentation 81, 81b may preferably extend, in a direction parallel to the plane defining the front surface 8 of the building panel 1 and into the building panel, no further than the mechanical locking device 20, or, even more preferred, shorter that then mechanical locking device 20.

Preferably, a tongue groove 31, which is to be formed, of the mechanical locking device 20 extends, after it has been formed, in a direction parallel to the plane defined by the front surface 8 of the building panel 1 and into the building panel 1, further than the indentation 81a does. On the other side of the building panel 1 a locking groove 24, which is to be formed, of the mechanical locking device 20 preferably extends, after is has been formed, in a direction parallel to the plane defined by the front surface 8 of the building panel 1 and into the building panel 1, further than the indentation 81b does. This is preferred since the indentations 81a, 81b should not affect either the process of forming the mechanical locking device 20 or the dimensions of such mechanical locking device 20. Thus, the remaining indentations, after the bevel 10 has been formed, are preferably to be removed during the forming of the mechanical locking device 20.

In fact, regardless of the final process steps along the edges of the building panel, e.g., calibrating, the remaining indentations, after the bevel has been formed, are preferably to be removed during such final process step.

In an embodiment the height Hi of the opening of the indentation 81a, 81b, prior to forming the bevel 10, is about equal to the height Hb of the bevel 10.

In another embodiment the height Hi of the opening of the indentation 81a, 81b, prior to forming the bevel 10, exceeds the height Hb of the bevel 10.

In an embodiment the length Li, in the direction parallel to the front surface 8 of the building panel 1 and into the building panel 1, of the indentation 81a, 81b is about equal to the radius Rb of the bevel 10.

In an embodiment the length Li, in the direction parallel to the front surface 8 of the building panel 1 and into the building panel 1, of the indentation 81a, 81b exceeds the radius Rb of the bevel 10.

Creating indentations as described above may be one way of mitigating the bevel forming process. Another way is to have a foamed sublayer, as also described above, which will allow the sublayer material to collapse in a controlled way when pressure is applied (not shown), i.e. the sublayer is able to change its density within an volume where the bevel is created. In an alternative process indentation as described above may still be created even if the sublayer is foamed.

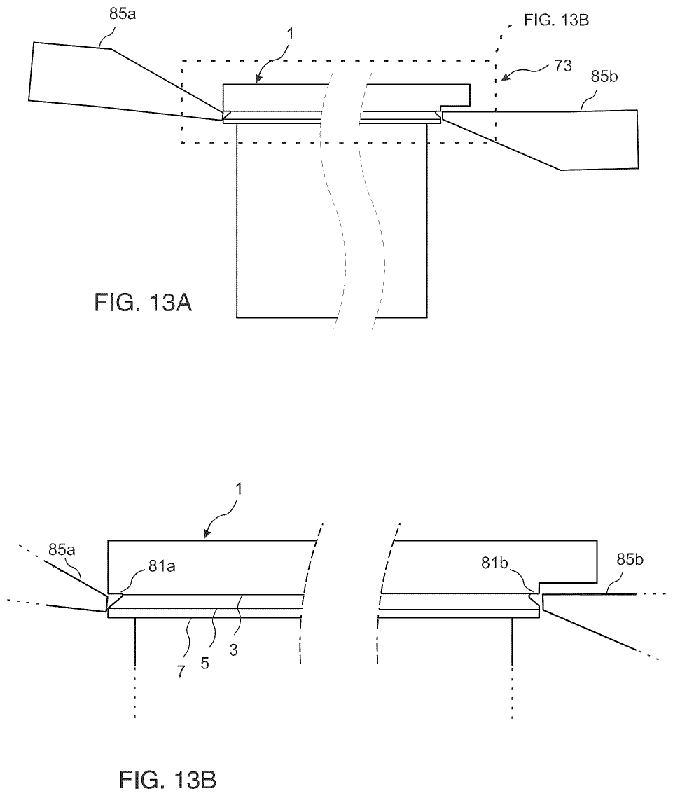

FIGS. 13A and 13B illustrate the next possible process which is a heating process 73, similar to the heating process 73 as described with reference to FIGS. 10A and 10B. There is provided one heating device 85a, 85b on each side of the building panel 1. Each heating device 85a, 85b is configured to heat an area in the edges of the building panel in which the bevel 10 is to be formed. The area which is heated on both sides has, preferably, a radius of at least 50% of the distance of which the indentation 81a, 81b extends into the building panel 1 from the opening of it. The temperature of the material in the area or surface in which the bevel 10 is to be formed is preferably at least 40-220° C. or 70-180° C. and it may depend on various properties, such as the thickness of the material, the type of material. The heating devices 85a, 85b may use IR or UV-heating, hot air, laser, ultra sound or contact heat for heating the area.

After the area has been heated in the heating process the bevel 10 of the building panel is formed, see FIGS. 14A-14C. The bevel forming process 75 is similar to the bevel forming process 75 as described with reference to FIGS. 10A and 10B. On each side of the building panel 1 there is provided a shaping device 77a, 77b configured to form a bevel 10 in each edge of the building panel by means of guiding and applying pressure to the surface layer 7 of the building panel 1. The shaping device 77a, 77b is configured to shape and press the surface layer 7, at least partially the sublayer 5 and sometimes even at least partially the substrate 3 upwards (since it is processed upside-down). During the shaping of the bevels 10, the shaping devices 77a, 77b press the material in each area, on each side of the building panel 1, where the bevel 10 is to be formed towards the indentations 81a, 81b. Thus the volume of the indentations 81a, 81b is decreased during the bevel forming process 75. The formed bevels 10 and the indentations 81a, 81b with decreased volume are illustrated in FIG. 14C. Alternatively, the volume of the indentations 81a, 81b after the bevel 10 has been formed may be decreased close to zero, i.e., no volume.

Details of the bevel forming process 75 described above with reference FIGS. 14A-14C apply to the bevel forming process 73 described with reference to FIGS. 10A-10B as well, with the exception for the indentation 81a, 81b.

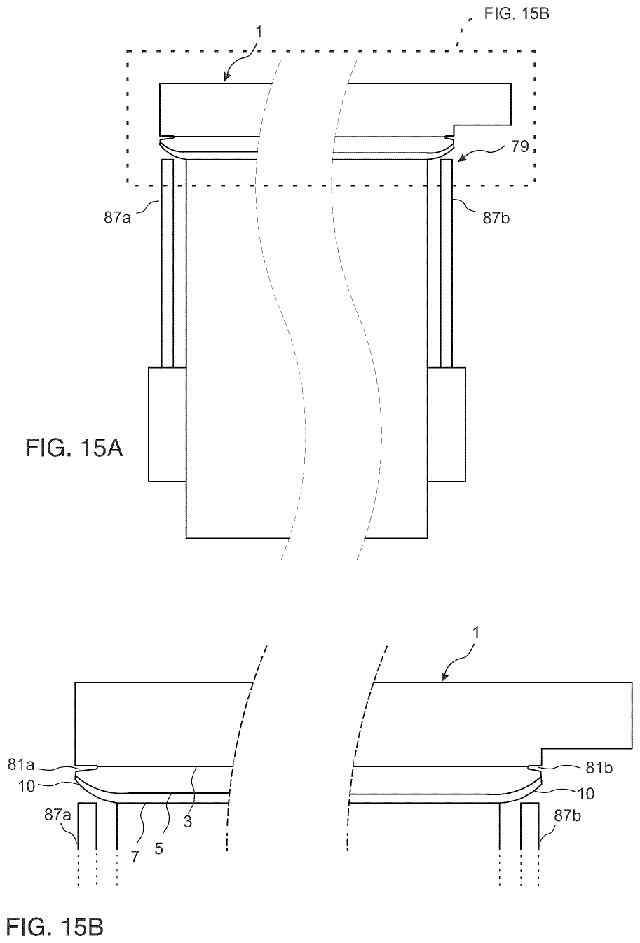

FIGS. 15A and 15B illustrate a cooling process 79 which is a preferred process step after forming the bevel 10 of the building panel 1. The cooling process 79 is similar to the cooling process 79 as described with reference to FIGS. 10A and 10B. On each side of the building panel 1 there is provided a cooling device 87a, 87b configured to cool respective bevel 10 and area in the edges of the building panel 1. The cooling process is advantageous in order to prevent an undesirable elasticity and/or recovery effect in the material of the bevel 10 and in order to maintain the shape and proportions of the bevel 10.

The cooling process 79 is preferably an active process in order to shorten the time compared to letting the temperature in the material decrease by means of the surrounding environment. The cooling process 79 may be achieved by a cooling device using air, liquid, gas, solid materials and/or other suitable means. The cooling device may perform the cooling through, e.g., blowing, spraying, evaporation and/or through contact.

The cooling process 79 may be configured to decrease the temperature, in the area of the material where the bevel is formed, between 15% and 40%. Depending on the type of cooling the cooling device uses and the temperature of such cooling the time spent by the cooling process may vary. For example, if cold water is used the cooling process may take between 2 sec. and 20 sec., and if cold air is used the cooling process may take between 30 sec. and 2 min, all depending on the type of cooling and the temperature.

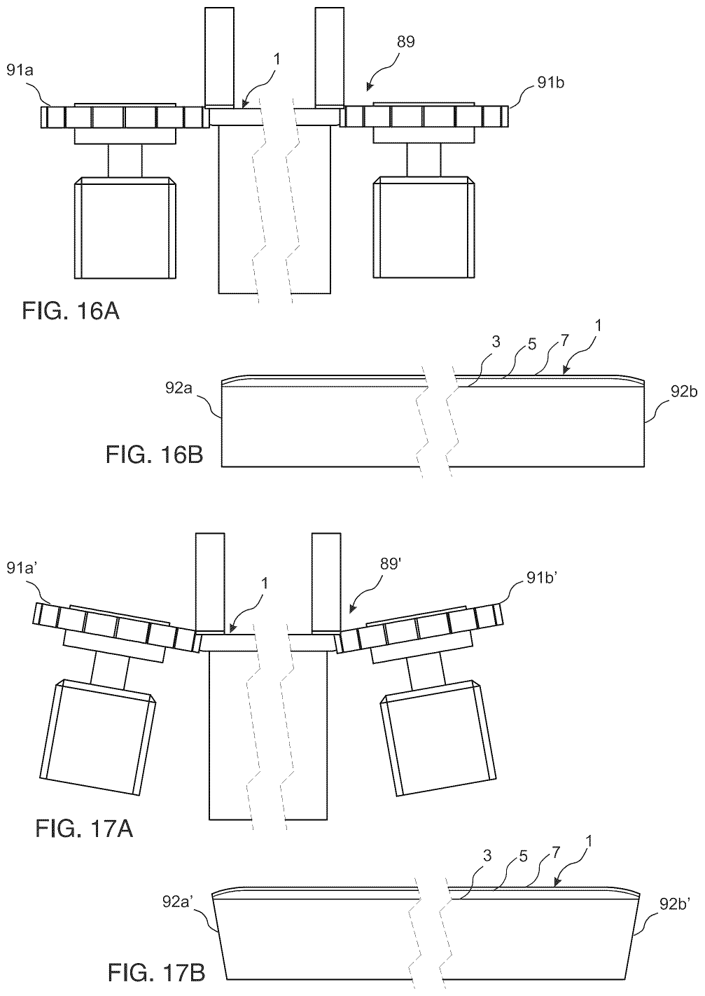

FIGS. 16A and 16B, FIGS. 17A and 17B, and FIGS. 18A and 18B illustrate three different types of calibrating processes, i.e. a final edge shaping processes, through which the building panel 1 might go through.

FIGS. 16A and 16B illustrate a first calibrating process including a second milling process 89 having a milling device 91a, 91b arranged on each side of the building panel 1. The milling devices 91a, 91b are configures to create a straight surface 92a, 92b along the edges of the building panel 1 as can be seen in FIG. 16B. The surfaces 92a, 92b of the edges extend in a direction perpendicular to the front surface 8. The surfaces 92a, 92b along the edges are preferably continuous surfaces.

If the building panel 1 was processed by the first milling process creating the indentation 81a, 81b then features of the indentations, e.g. gaps or similar, are no longer present after the calibrating process of creating the straight surfaces 92a, 92b of the edges. Further, the second milling process 89 is configured to create the desirable length of the bevel 10 and remove excess material from each edge of the building panel 1.

FIGS. 17A and 17B illustrate a second calibrating process including an alternative second milling process 89′ having a milling device 91a′, 91b′ arranged on each side of the building panel 1. The milling devices 91a′, 91b′ are configured to create an angled surface 92a′, 92b′ along the edges of the building panel 1 as can be seen in FIG. 17B. The surfaces 92a′, 92b′ of the edges extend in a direction tilting inwards from the front surface 8 to the back surface 4 of the building panel 1. The surfaces 92a′, 92b′ along the edges are preferably continuous surfaces.

If the building panel 1 was processed by the first milling process creating the indentation 81a, 81b then features of the indentations, e.g. gaps or similar, are, in an embodiment, no longer present after the calibrating process of creating the angled surfaces 92a′, 92b′ of the edges. Further, the second milling process 89′ is configured to create the desirable length of the bevel 10 and remove excess material from each edge of the building panel 1.

FIGS. 18A-18C illustrate a third calibrating process including another alternative second milling process 89″. This second milling process 89″ may include one or several milling devices 91a″, 91b″ although two are illustrated in FIGS. 18A-18C. This second milling process 89″ has a milling device 91a″, 91b″ arranged on each side of the building panel 1. The milling devices 91a″, 91b″ are configured to create a mechanical locking device 100, 100′ along the edges of the building panel 1. One type of mechanical locking device 100 is illustrated in FIG. 18C. Other possible types of mechanical locking devices 100, 100′ are described with reference to FIGS. 4A-6C. Depending on what type of mechanical locking device 100, 100′ is to be created one or several milling devices 91a″, 91b″ are present within the second milling process 89″.

If the building panel 1 was also processed by the first milling process creating the indentation 81a, 81b then features of the indentations, e.g. gaps or similar, are, in an embodiment, no longer present after the calibrating process of creating the mechanical locking device 100, 100′. Further, the second milling process 89″ is configured to create the desirable length of the bevel 10 and remove excess material from each edge 15, 16 of the building panel 1.

FIGS. 19A-19D illustrate a cross section of a building panel 1 finally process in a slightly different way compared to what was illustrated and described with reference to FIGS. 11-18. The alternative possible set up for final processing of the building panel 1 is suitable when having a substrate 3 being sufficiently able to be plastically deformable under the influence of pressure and preferably also heat.

FIG. 19A illustrates the cross section of the building panel 1, before the final processing, with the substrate 3, the sublayer 5 and the surface layer 7 after being joined together by pressure and preferably also heat.

FIG. 19B illustrates the building panel 1 after the process of creating indentations 81a, 81b. As can be seen the indentations 81a, 81b are partly or entirely created in the substrate 3. The indentations 81a, 81b are created such that their locations are suitable for the later intended calibrating process of the edges. In this example, the later intended calibrating process is a process to create a mechanical locking device and therefore the indentations 81a, 81b are created in positions matching or coordinating with the intended mechanical locking device.

In order to form the bevels 10 the area of the building panel 1 between the indentations 81a, 81b and its surface in which the bevels 10 are to be formed, which in the illustrated examples is the front surface 8 of the building panel 1, may need to be sufficiently heated. This may be achieved by any of the above described possible processes, e.g. by a separate heating process, by an incorporated heating process or by immediately transporting the building panel from the forming process when at least the area between the indentations 81a, 81b and the surface in which the bevels are to be formed is still sufficiently hot.

FIG. 19C illustrates the cross section of the building panel 1 after the bevels 10 have been formed and after the preferred cooling process 79. The volume of each the indentation 81a, 81b has been decreased since material from the area between the indentation 81a, 81b and the surface in which the bevel 10 is now formed has been pressed into the indentation 81a, 81b. Thus, the shape of each indentation 81a, 81b has changed.

FIG. 19D illustrates the cross section of the building panel 1 after a calibrating process where a mechanical locking device 100 has been created in the edges of the building panel 1. The remaining indentations 81a, 81b, after the bevel forming process, are no longer present after the calibrating process of creating the mechanical locking device 100. However, in an embodiment, at least some space previously occupied by the indentations is now open space of the locking system. Further, the desirable length of the bevel 10 has been created by the calibrating process.

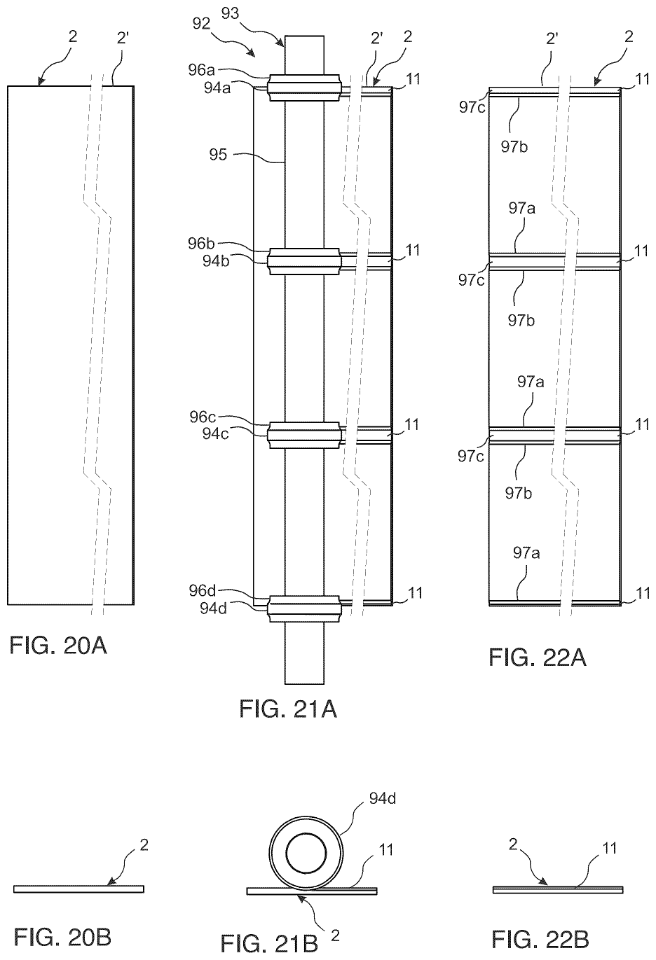

FIGS. 20-25 illustrate different steps of a possible set up for processing a panel board 2 and creating several building panels 1 from that panel board 2. FIGS. 20A and B illustrate a panel board 2. The panel board 2 includes the same layers as the building panels 1 created from it, i.e. a single-layer or multi-layer substrate 3, a sublayer 5 which is plastically deformable under pressure and a surface layer 7, preferably including a decorative layer and a wear layer. It is clear that all previously described materials, layers and manufacturing methods used for forming a building panel 1 also applies for forming the panel board 2 since the final product of the panel board 2 is the building panel 1 as described above with reference to e.g. FIGS. 1-9. FIGS. 20A and 20B illustrate the panel board 2 after all layers have been joined together by pressure and preferably heat.

FIGS. 21A and 21B illustrate a groove forming process 92 for forming one or several grooves 11 in the panel board 2. The groove forming process 92 includes a pressing device 93 having one or several pressing elements 94a-94d, in the illustrated example there are four pressing elements 94a-94b. The pressing elements 94a-94d are arranged spaced apart at a predetermined distance along a rod element 95. The distance between each pressing element 94a-94d is determined by the proportions of the later created building panels 1, e.g. by the width of the building panel 1.

The pressing elements 94a-94d preferably have a circular shape so that the pressing elements 94a-94d are able to roll over the panel board 2. An outer shape of each pressing element 94a-94d has a curved outer surface 96, e.g. a convex surface or a curved surface having sections of different shapes, where the curved outer surface 96 creates the groove 11 in the panel board 2. The pressing elements 94a, 94d arranged at an outer rim 2′ of the panel board 2 are configured to create at least one sloped surface 97a, 97b in the panel board 2 by means of its curved outer surfaces 96. The sloped surface 97a, 97b in the panel board 2 will later become a bevel 10 of a building panel 1. The pressing elements 94b, 94c arranged away from the outer rim 2′ of the panel board 2 are configured to create two sloped surfaces 97a, 97b in the panel board 2 by means of its curved outer surfaces 96. The two sloped surfaces 97a, 97b in the panel board 2 will each later become a bevel 10 of a building panel 1. In between the two sloped surfaces 97a, 97b of the panel board 2 there may be an intermediate surface 97c in which a cutting device will later cut the panel board 2 into building panels 1, separating the two sloped surfaces 97a, 97b.

The groove forming process 92 may further include a heating device (not shown). The heating device may be a separate device or incorporated in the pressing device 93. Heating the area of the panel board in which the groove 11 is to be created may make the groove forming process 92 easier. Depending on the set up of the processes of the manufacturing method a heating device may not be necessary. If the panel board 2 is transported directly from the process where the panel board 2 is formed by means of heat and pressure, the panel board may in fact still be sufficiently hot for making the grooves 11 by the pressing device 93. Thus, there are a multiple possible set ups for the manufacturing process. The at least one groove 11 may be created simultaneously as the panel board is formed by means of heat and pressure (described below), or the at least one groove 11 may be formed in a process subsequent of the process forming the panel board 2 but where the heat used in the process of forming the panel board 2 is sufficient for the subsequent groove forming process, or the at least one groove 11 may be formed in a process subsequent of the process forming the panel board 2 where the groove forming process includes heating at least the area of the panel board 2 in which the groove is to be created, or even having a groove forming process without heat, just using pressure to form the at least one groove 11.

If heat is used, in either way, to form the at least one groove 11 in the panel board 2, is preferred to have a cooling process (not shown), like the one described above when forming a bevel in the building panel with reference to FIGS. 15A and 15B. Thus, such a cooling process is likewise applicable to the method of forming a groove in a panel board as to forming a bevel in a building panel.

The result of the groove forming process 92 can be seen in FIGS. 22A and 22B.

An alternative method (not shown) to the above described groove forming process is to press at least one groove, with the sloped surfaces, into the panel board simultaneously as forming the panel board and joining the layers, i.e., the substrate, sublayer, and surface layer, together. The at least one groove may be created with the same pressing device simultaneously as forming the panel board. The pressing device may then preferably be provided with features, e.g. protrusions, for creating such grooves with sloped surfaces configured to be bevels of later formed building panels.

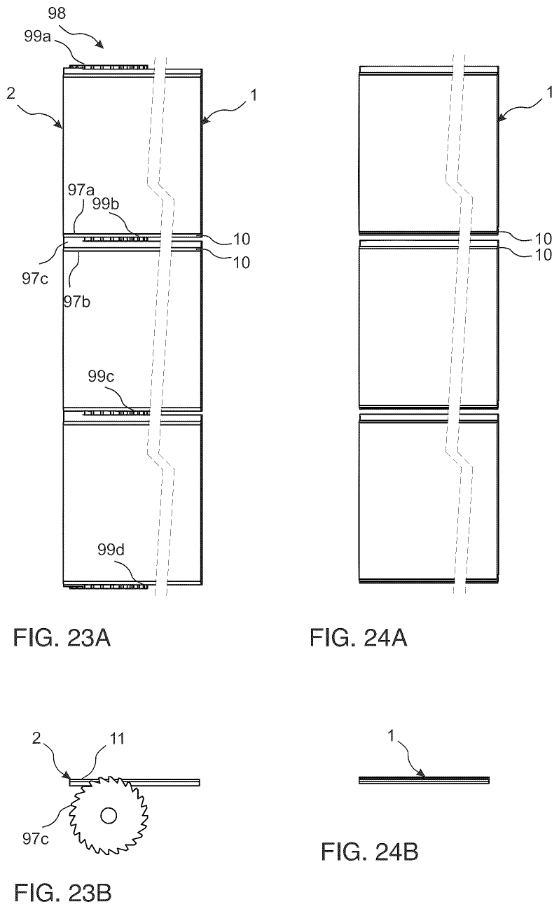

After the groove forming process the panel board 2 enters the cutting process 98 where several building panels 1 are created from the panel board 2, illustrated in FIGS. 23A and 23B. The cutting process 98 includes one or several, four in the illustrated example, cutting devices 99a-99d. In the illustrated example the cutting devices 99a-99d are saws but may in other examples be other types of cutting devices, e.g., punching device or laser. The cutting devices 99a-99d are arranged spaced apart at a predetermined distance and configured to cut the panel board 2 so that the building panels 1 get their desired proportions. The cutting devices 99a-99d are configured to cut in between the sloped surfaces 97a, 97b, created by the groove forming process 92, in the intermediate surface 97c of each groove 11.

Further, it is possible that the cutting process 98 further includes any one of the previously described calibrating processes, i.e. final edge shaping processes of the building panel 1, described with reference to FIGS. 16A and 16B, FIGS. 17A and 17B, and FIGS. 18A and 18B.

A possible result of the cutting process 98 can be seen in FIGS. 24A and 24B, with several building panels 1 arranged next to each other and each building panel 1 provided with a mechanical locking device 100.

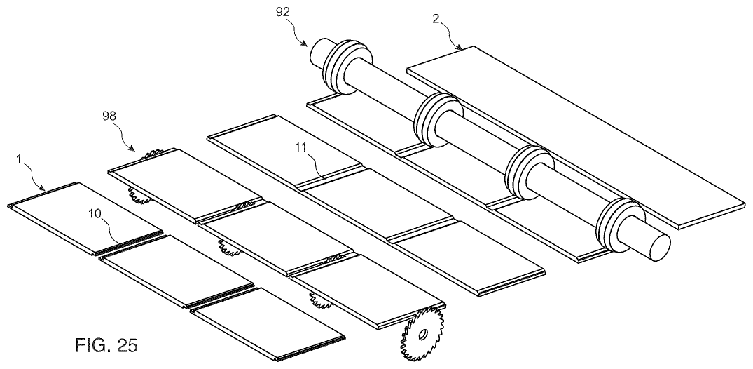

FIG. 25 is an overview of the steps of creating building panels 1 with bevels 10 from a panel board 2 in accordance with the method as described above and with reference to FIGS. 20A-24B.

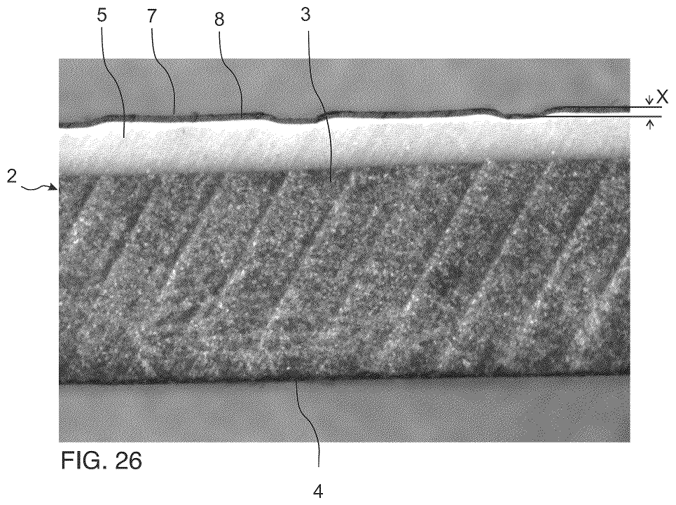

Below is an example from testing a groove forming process 92. The photograph of FIG. 26 shows the result from mixing 40 g of plasticizer with 300 g of a PVC blend according to Table 1. In Table 2, the resulting depth of groove from testing different amounts of plasticizer with the PVC blend is shown.

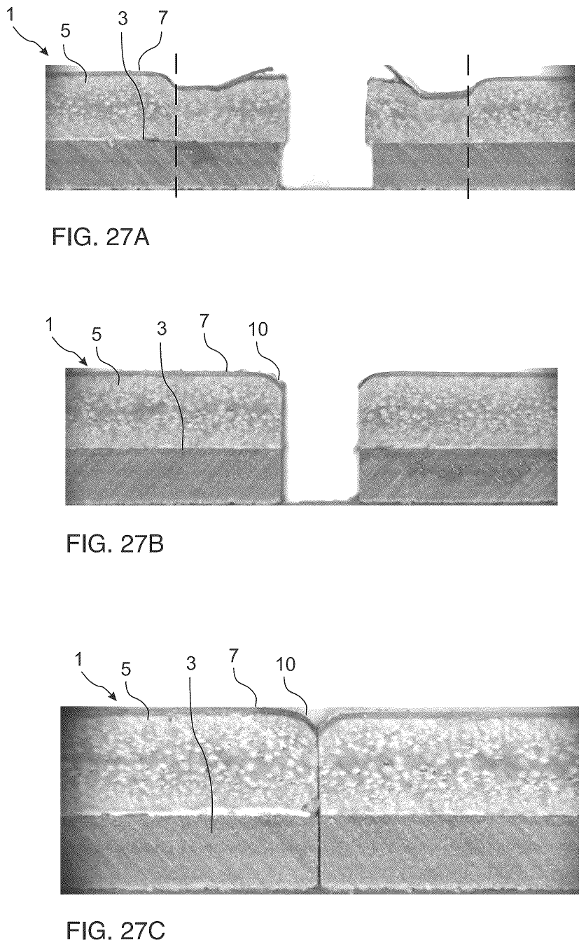

The photographs of FIGS. 27A-27C show the result from testing a bevel forming process where the building panels 1 each have a sublayer 5 that is foamed. In the example shown, the sublayer 5 is made of foamed PET. Tests showed that a bevel pressed at any of the temperature between 100° C. and 140° C. achieved the same beneficial result as shown in FIGS. 27A-27C.

FIG. 27A is a photo of the two building panels 1 after creating the intended edges, e.g. by a method illustrated in FIGS. 14A-14C but prior to cutting the building panels. FIG. 27B is a photo of the two building panels in FIG. 27A after the edges have been cut. FIG. 27C is a photo of the two building panels in FIG. 27B placed adjacent each other to illustrate a possible assembled position, in this case without a mechanical locking device.

### Example

Below is the result of a test presented showing the correlation between the groove forming, using a predetermined temperature, pressure and time, and the content of the sublayer.

A number of building panels having the same core, the same surface layer but sublayers with different amount of plasticizer were manufactured in a pressing device at a pressure of 20 bar, a temperature of 80° C. during 35 seconds. The pressing device is equipped with a top press plate having rills that are 1.2 mm. deep. The grooves created in the building panel by the press plate were then measured. The results are to be seen in Table 2 below.

Two reference tests were made, one without any sublayer having only the substrate and the surface layer, including a decorative layer and the wear layer. The other one having a sublayer, in between the substrate and the surface layer, where the sublayer has no plasticizer in the blend.

The substrate used in the test was a SPC core, commonly used within the field. The surface layer included a decorative print layer and a wear layer, where the print layer was arranged on top of the plastically deformable sublayer and the wear layer was arranged on top of the print layer.

For the testing, a PVC blend was mixed with different amount of a plasticizer. The main PVC blend receipt is defined in Table 1. Most of the blend consists of PVC (68.97%) and the inorganic filler chalk (22.07%).

TABLE 1
PVC blend recipe
PVC blend recipe

| | PHR (Parts per | |
|---|---|---|
| Raw material | hundred resin) | Weight % |
| Norvinyl S5745 | 100 | 68.97% |
| Baerostab CT 1228 R | 10 | 6.90% |
| Baerolub PA Special | 2 | 1.38% |
| Baerolub PA 200 | 1 | 0.69% |
| Omyacarb 40 GU | 32 | 22.06% |
| Total: | 145 | 100% |

The PVC blend, according to Table 1, of 300 g was mixed with different amounts of plasticizer, according to Table 2. The plasticizer (Plast.) used for the test was Eastman 168. The groove of each test was measured, the depth value X of the groove is measured from the upper surface of the wear layer in between two grooves, to the bottom of the groove.

TABLE 2
Sublayer with different amount of plasticizer

| | Weight % of | Depth of groove |
|---|---|---|
| Sublayer | Plasticizer | X (mm) |
| SPC core + no sublayer | — | 0.027 |
| PVC blend + no Plast. | 0 | 0.027 |
| PVC blend + 8 g Plast. | 2.6 | 0.041 |
| PVC blend + 20 g Plast. | 6.3 | 0.041 |
| PVC blend + 27 g Plast. | 8.3 | 0.069 |
| PVC blend + 40 g Plast. | 11.8 | 0.124 |
| (shown in FIG. 26) | | |
| PVC blend + 60 g. Plast | 16.7 | 0.110 |
| PVC blend + 80 g Plast. | 21.1 | 0.110 |
| PVC blend + 100 g Plast. | 25.0 | 0.124 |

A conclusion to be drawn from the result of the tests is that a plasticizer in the material blend of the sublayer provides the sublayer with the desirable plastically deformable feature. Further, the depth of the groove in the building panel increases with the amount of plasticizer in the blend.

Finally, although the inventive concept has been described above with reference to specific embodiments, it is not intended to be limited to the specific form set forth herein. Rather, the invention is limited only by the accompanying claims. Other embodiments than the specific above are equally possible within the scope of the appended claims. All embodiments may be used separately or in combinations. Angles, dimensions, rounded parts, spaces between surfaces, etc. are only examples and may be adjusted within the basic principles of the invention.

Item Section

Item 1. A method to manufacture a building panel (1), such as a floor panel or wall panel, comprising:
joining a substrate material and a sublayer material to form a substrate (3) and a sublayer (5) of the building panel (1), wherein the sublayer material comprises a polymer-based material,
applying a surface layer (7) on the sublayer (5),
applying pressure to form said building panel (1), and
forming a bevel (10) along at least one edge (15, 16, 17, 18) of the building panel (1) by applying pressure by means of a pressing device and by plastic deformation of the sublayer (5).

Item 2. The method according to item 1, wherein applying pressure to form said building panel (1) further comprises applying heat.

Item 3. The method according to item 1 or 2, wherein forming the bevel (10) along said at least one edge (15, 16, 17, 18) of the building panel (1) by means of the pressing device further comprises applying heat.

Item 4. The method according to any one of the preceding items, further comprising cooling after forming the bevel (10) by means of the pressing device.

Item 5. The method according to any one of the preceding items, wherein the polymer-based material of the sublayer material forming the sublayer (5) is a thermoplastic material.

Item 6. The method according to any one of the preceding items, wherein the sublayer material further comprises at least one filler, and wherein said filler preferably is at least one mineral-based filler.

Item 7. The method according to any one of the preceding items, further comprising:
creating an indentation (81a, 81b) in an edge portion of the at least one edge (15, 16, 17, 18) of the building panel (1) prior to forming the bevel (10) along the at least one edge (15, 16, 17, 18) of the building panel (1) by means of a pressing device.

Item 8. The method according to item 7, further comprising:
heating at least an area between the indentation (81a, 81b) and a surface (4, 8) of the building panel (1) prior to forming the bevel (10) along the at least one edge (15, 16, 17, 18) of the building panel (1) by means of the pressing device.

Item 9. The method according to any one of the preceding items, further comprising:
calibrating at least one edge (15, 16, 17, 18) of the building panel (1) after forming the bevel (10) along the at least one edge (15, 16, 17, 18) of the building panel (1) by means of the pressing device.

Item 10. The method according to any one of the preceding items, further comprising:
creating a mechanical locking device (100, 100′) along at least one edge (15, 16, 17, 18) of the building panel (1), wherein the mechanical locking device (100, 100′) is configured for horizontal and/or vertical locking of similar or essentially identical building panels (1, 1′, 1″) in an assembled position.

Item 11. A method for manufacturing a building panel (1), such as a floor panel or wall panel, comprising
joining a substrate material and a sublayer material to form a substrate (3) and a sublayer (5) of a panel board (2), wherein the sublayer material comprises at least a polymer-based material,
applying a surface layer (7) on the sublayer (5),
applying pressure to form the panel board (2),
forming a groove (11) in said panel board (2) by applying pressure by means of a pressing device and by plastic deformation of the sublayer (5), and
forming a building panel (1) out of said panel board (2),
wherein said groove (11) is configured to form a bevel (10) along at least one edge (15, 16, 17, 18) of the building panel (1).

Item 12. The method according to item 11, wherein the polymer-based material of the sublayer material forming the sublayer (5) is a thermoplastic material.

Item 13. The method according to item 11 or 12, wherein the sublayer material further comprises at least one filler, and wherein said filler preferably is at least one mineral-based filler.

Item 14. The method according to any one of the items 11-13, wherein forming said groove (11) in the panel board (2) is done subsequently of forming said panel board (2).

Item 15. The method according to any one of items 11-14, wherein forming the building panel (1) out of said panel board (2) comprising cutting said panel board (2) at the groove (11).

Item 16. The method according to any one of the items 11-15, wherein applying pressure to form said panel board (2) and/or to form said groove (11) further comprises applying heat.

Item 17. The method according to any one of the items 11-16, further comprising cooling after forming the groove (11) in said panel board (2).

Item 18. The method according to any one of the items 11-17, further comprising:
calibrating said at least one edge (15, 16, 17, 18) of the building panel (1) after forming the building panel (1) out of said panel board (2).

Item 19. The method according to any one of the items 11-18, further comprising:
creating a mechanical locking device (100, 100′) along at least one edge (15, 16, 17, 18) of the building panel (1) after forming the building panel (1) out of said panel board (2), wherein the mechanical locking device (100, 100′) is configured for horizontal and/or vertical locking of similar or essentially identical building panels (1, 1′, 1″) in an assembled position.

Item 20. A building panel manufactured by a method according to any one of the preceding items.

Item 21. A method to form a bevel along at least one edge of a building panel, comprising
providing a building panel (1) comprising a substrate (3), a sublayer (5), and a surface layer (7), wherein the sublayer (5) is arranged between the substrate (3) and the surface layer (7), and wherein the sublayer (5) comprises a polymer-based material, and
forming a bevel (10) along at least one edge (15, 16, 17, 18) of the building panel (1) by plastic deformation of the sublayer (5).

Item 22. The method according to item 21, wherein forming the bevel (10) along at least one edge (15, 16, 17, 18) of the building panel (1) by plastic deformation of the sublayer (5) comprises applying pressure by a pressing device.

Item 23. The method according to items 21 or 22, wherein forming the building panel (1) comprises joining the substrate (3), the sublayer (5) and the surface layer (7) by applying pressure to form the building panel (1).

Item 24. The method according to item 22 or 23, wherein applying pressure by the pressing device to form the bevel (10) is made subsequent to applying pressure to form the building panel (1).

Item 25. A method to form a bevel along at least one edge of a building panel, comprising
providing a panel board (2) comprising a substrate (3), a sublayer (5), and a surface layer (7), wherein the sublayer (5) is arranged between the substrate (3) and the surface layer (7), and wherein the sublayer (5) comprises a polymer-based material, and
forming a groove (11) in the panel board (2) by plastic deformation of the sublayer (5),
forming at least one building panel (1) out of the panel board (2), and
wherein the groove (11) is configured to form a bevel (10) along at least one edge (15, 16, 17, 18) of said at least one building panel (1).

Item 26. The method according to item 25, wherein forming the groove (11) along at least one edge (15, 16, 17, 18) of the building panel (1) by plastic deformation of the sublayer (5) comprises applying pressure by a pressing device.

Item 27. The method according to item 25 or 26, wherein forming the panel board (2) comprises joining the substrate (3), the sublayer (5) and the surface (7) by applying pressure to form the panel board (2).

Item 28. The method according to item 26 or 27, wherein applying pressure by the pressing device to form the groove (11) is made subsequent to applying pressure to form the building panel (1).

Item 29. The method according to any one of items 25-28, wherein forming the building panel (1) out of said panel board (2) comprising cutting said panel board (2) at the groove (11).

1. A method to form a bevel along at least one edge of a building panel, comprising
providing a building panel comprising a substrate, a sublayer, and a surface layer, wherein the sublayer is arranged between the substrate and the surface layer, and wherein the sublayer comprises a polymer-based material, and
forming a bevel along at least one edge of the building panel by applying pressure by means of a pressing device and by plastic deformation of the sublayer.

2. The method according to claim 1, wherein forming the bevel along said at least one edge of the building panel further comprises applying heat.

3. The method according to claim 1, further comprising cooling the bevel by means of a cooling device after forming the bevel.

4. The method according to claim 1, further comprising:
creating an indentation in an edge portion of the at least one edge of the building panel prior to forming the bevel along the at least one edge of the building panel.

5. The method according to claim 4, further comprising:
heating at least an area between the indentation and a surface of the building panel prior to forming the bevel along the at least one edge of the building panel.

6. The method according to claim 1, further comprising:
calibrating at least one edge of the building panel after forming the bevel along the at least one edge of the building panel.

7. The method according to claim 1, wherein the polymer-based material of the sublayer material forming the sublayer is a thermoplastic material, and wherein the amount of thermoplastic material in the sublayer material preferably is at least 10 wt %, at least 15 wt % or at least 20 wt %.

8. A method to manufacture a building panel, such as a floor panel or wall panel, comprising:
joining a substrate material and a sublayer material to form a substrate and a sublayer of the building panel, wherein the sublayer material comprises a polymer-based material,
applying a surface layer on the sublayer,
applying pressure to form said building panel, and
forming a bevel along at least one edge of the building panel by means of the method according to claim 1.

9. The method according to any claim 8, wherein the polymer-based material of the sublayer material forming the sublayer is a thermoplastic material, and wherein the amount of thermoplastic material in the sublayer material preferably is at least 10 wt %, at least 15 wt % or at least 20 wt %.

10. The method according to claim 8, wherein the sublayer material further comprises at least one filler, and wherein said filler preferably is at least one mineral-based filler.

11. The method according to claim 8, further comprising:
creating a mechanical locking device along at least one edge of the building panel, wherein the mechanical locking device is configured for horizontal and/or vertical locking of similar or essentially identical building panels in an assembled position.

12. The method according to claim 8, wherein applying pressure to form the bevel is made subsequent of applying pressure to form the building panel.

13. A method to form a bevel along at least one edge of a building panel, comprising
providing a panel board comprising a substrate, a sublayer, and a surface layer, wherein the sublayer is arranged between the substrate and the surface layer, and wherein the sublayer comprises a polymer-based material,
forming a groove in the panel board by applying pressure by means of a pressing device and by plastic deformation of the sublayer, and
forming at least one building panel out of the panel board, and
wherein the groove is configured to form a bevel along an edge of said at least one building panel.

14. The method according to claim 13, wherein forming the building panel out of said panel board comprising cutting said panel board in the groove.

15. The method according to claim 13, further comprising cooling the groove by means of a cooling device, after forming the groove in said panel board.

16. A method for manufacturing a building panel, such as a floor panel or wall panel, comprising
joining a substrate material and a sublayer material to form a substrate and a sublayer of a panel board, wherein the sublayer material comprises a polymer-based material,
applying a surface layer on the sublayer,
applying pressure to form the panel board,
forming a groove in said panel board by applying pressure by means of a pressing device and by plastic deformation of the sublayer, and
forming a building panel out of said panel board,
wherein said groove is configured to form a bevel along an edge of the building panel.

17. The method according to claim 16, wherein applying pressure by the pressing device to form the groove is made subsequent to applying pressure to form the panel board.

18. The method according to claim 16, wherein the polymer-based material of the sublayer material forming the sublayer is a thermoplastic material.

19. The method according to claim 16, wherein forming the building panel out of said panel board comprising cutting said panel board in the groove.

20. The method according to claim 16, wherein applying pressure to form said panel board and/or to form said groove further comprises applying heat.

21. The method according to claim 16, further comprising:
calibrating said at least one edge of the building panel after forming the building panel out of said panel board.

22. The method according to claim 16, further comprising:
creating a mechanical locking device along at least one edge of the building panel after forming the building panel out of said panel board, wherein the mechanical locking device is configured for horizontal and/or vertical locking of similar or essentially identical building panels in an assembled position.
